(19) United States
(12) Patent Application Publication
(10) Pub. No.: US 2026/0250458 A1
(43) Pub. Date: Aug. 27, 2026

(54) PHOSPHONATE EPOXY THERMOSETS

(71) Applicant: EMPA EIDGENÖSSISCHE MATERIALPRÜFUNGS- UND FORSCHUNGSANSTALT, Dubendorf (CH)

(72) Inventors: WENYU WU KLINGLER, Niederwil (CH); SABYASACHI GAAN, Gossau (CH)

(21) Appl. No.: 19/115,659

(22) PCT Filed: Sep. 25, 2023
(86) PCT No.: PCT/EP2023/076432

§ 371 Date: Mar. 26, 2025

(30) Foreign Application Priority Data
Sep. 26, 2022 (EP) 22197836.4

(51) Int. Cl. C08G 59/32; C08G 59/18; C08G 59/50; C09D 5/18; C09D 163/00; C09D 185/02

(52) U.S. Cl. CPC C08G 59/3272; C08G 59/186; C08G 59/5026; C08G 59/5033; C09D 5/185; C09D 163/00; C09D 185/02

(57) ABSTRACT

The present invention is directed to epoxy thermoset polymers comprising phosphorous and phosphonate triple-bonded epoxy thermosets with the phosphonate forming chain members within the epoxy thermoset polymer network and being covalently triple bonded to the polymer network via a phosphonate P—C and two P—O bonds. The invention also encompasses methods for preparing these epoxy thermoset polymer, their uses and products comprising a thermoset epoxy polymer of the invention.

The present invention is directed to epoxy thermoset polymers comprising phosphorous and phosphonate triple-bonded epoxy thermosets with the phosphonate forming chain members within the epoxy thermoset polymer network and being covalently triple bonded to the polymer network via a phosphonate P—C and two P—O bonds. The invention also encompasses methods for preparing these epoxy thermoset polymer, their uses and products comprising a thermoset epoxy polymer of the invention.

Thermoset polymers are normally formed from liquid comonomer solutions and irreversibly result in a tri-dimensional cross-linked solid material after a curing step by external action, such as heating or UV irradiation. The unrivaled performance with low cost, easy availability, and versatility, makes them indispensable, e.g. in packaging, transport, and construction of consumer electronics, automotive, and aeronautics applications. They comprise about 20 percent of all polymeric materials manufactured today, with a worldwide annual production of about 65 million tons. Epoxy based resins account for about 70% of the thermoset polymers and more than 60% of the global production is used in the coatings industry. Epoxies are the most versatile family of engineering/structural adhesives due to their compatibility with many substrates, easy modification and widely varying properties.

The two major drawbacks of thermosets are their inherent flammability and their intrinsic resistance to deformation because of the highly covalently cross-linked networks, consequently rendering them not re-processable nor recyclable. The two major current approaches to challenge thermoset polymer's inherent flammability are the inclusion of inorganic or organic additives through physical doping and the reactive addition of flame retardants, e.g., DOPO, that form pendant covalent linkage to the terminal sites of the epoxy network. However, both methods result in leakage issues or insufficient flame retardancy.

U.S. Pat. No. 4,070,336A teaches hydrogen phosphonates, in particular bicyclic H-phosphonate, and polymer compositions containing them as flame retardants.

EP79300349A is directed to polymeric pentaerythrityl phosphonates useful as flame retardants for polyolefins.

EP0530874A2 reads on pentaerythrityl-phosphonates and their utility for fire-retardant thermoplastic polymer compositions.

WO2020075519 relates to polymeric pentaerythrityl phosphonate flame retardants added to synthetic resins, in particular polyester-based resins.

EP0420811 discloses thermoset materials made from the ring opening reaction of epoxy with cyclic phosphite starting materials, using nucleophilic addition instead of the Arbuzov reaction.

In summary, phosphonate additives are known as fire retardant components for polymer compositions but these did not interact covalently with the polymer matrix.

Furthermore, European Polymer Journal, 2021, 144, 110236 teaches phosphate-based adaptable covalent epoxy networks with reprocessing and recyclability properties and flame retardancy. However, the thermoset polymer network is sensible to environmental impacts and pH.

It is the objective of the present invention to provide improved polymers, in particular epoxy thermoset polymers with improved properties, e.g. flame retardancy, self-healing, damage resistancy, re-processing capacity, pH and environmental stability, recyclability, and/or transparency.

This objective is solved in a first aspect by an epoxy thermoset polymer comprising 0.5 to 10 wt-% phosphorous, and- phosphonate triple-bonded epoxy thermosets, wherein the phosphonate forms a chain member within the epoxy thermoset polymer network and is covalently triple-bonded to the polymer network via a phosphonate P—C and two P—O bonds.

The term “epoxy thermoset polymer”, as used herein, is meant to be interpreted as commonly used in the relevant polymer art, and, in particular, as indicating any organic polymer compound featuring a three-membered reacted epoxide moiety also known as epoxy/oxirane/epoxide or ethoxyline group. An epoxy prepolymer with more than one epoxide group having low molecular weight is understood to be an epoxy resin. Epoxy resins for optional use in the present invention can be selected from various types, e.g. bisphenol-based, optionally bisphenol-A-based, aliphatic, cycloaliphatic, aromatic, bis, tris and multifunctional, halogenated, Novolak and glycidylamine based epoxy resins, etc. Thermosets, also called duroplastics, are heat-setting polymers with fixed polymer network structures at operating structures when reaction kinetics are frozen.

The epoxy thermoset polymer comprises 0.5 to 10 wt-% phosphorous based on the phosphorous atom weight, not the phosphonate. The phosphorous content can be determined by common analysis techniques in the art, e.g. by inductively coupled plasma optical emission spectrometry method (ICP-OES) (see the example section below). For example, the phosphorous content in the polymer comprises of the present invention can vary from 1 to 8 or 2 to 6 wt-% phosphorous.

The phosphonate component in the epoxy thermoset polymer of the invention forms an integrated chain member within the epoxy thermoset polymer network and is covalently triple-bonded to the polymer network via a phosphonate P—C and two P—O bonds. Without wishing to be bound by theory, it is the phosphonate polymer network integration that imparts the improved properties of the epoxy thermoset polymer, for example, the thermosetting properties in combination with excellent fire retardancy and re-processability and recyclability upon heat treatment and the resulting transesterification of the phosphonate P—O bonds, whereas the P—C bond stays in place within the epoxy network.

The polymer network-integrated phosphonate of the polymers of the invention can result in epoxy-based “vitrimer”-type thermoset polymers. The polymers of the invention and other vitrimers are a class of plastics, which are derived from thermosetting polymers and feature molecular, covalent networks, which can alter their topology by thermally activated bond-exchange reactions. At higher temperatures polymers of the invention and other vitrimers may flow like viscoelastic liquids, whereas at lower temperatures the bond-exchange reactions are immeasurably slow (frozen) and they perform like classical thermosets. Because of their bond-exchange reactions, these thermosets have utility as self-healing material and allow easy re-processibility in a wide temperature range.

In the polymers of the invention it is the dynamic associative P—O bonds that provide for self-healing, damage resistance and recyclability with easy operative treatment. The P—C bond of the phosphonate with the epoxy-based polymer network is hydrolytically more stable than the P—O phosphate bonds.

Depending on the epoxy reactants as starting material and the reaction conditions for preparing the epoxy thermoset polymers of the present invention, in further embodiments some further phosphonates may attach double or mono-bonded, e.g. terminally too.

The epoxy thermoset polymer of the present invention may be one, wherein the phosphonate in the polymer has formula (I)

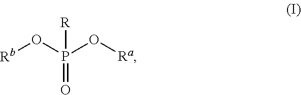

wherein
R is a reacted epoxy moiety within the epoxy thermoset polymer,
R^{a} and R^{b} are selected from reacted epoxy moieties and/or a further phosphonate moiety coupled to at least one reacted epoxy moiety within the epoxy thermoset polymer,
all of R, R^{a} and R^{b} are directly or indirectly bound to reacted epoxy moieties.

In this embodiment the epoxy thermoset polymer of the invention features a phosphonate that is triple-bonded to the reacted epoxy moiety either directly or indirectly depending on the phosphonate reactant and the epoxy reactants used.

In an alternative embodiment the epoxy thermoset polymer of the invention is one, wherein the phosphonate in the epoxy thermoset polymer has formula (II)

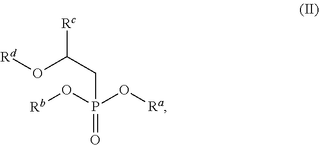

wherein
R^{a} and R^{b} are reacted epoxy moieties and/or a further phosphonate moiety coupled to at least one epoxy moiety within the epoxy thermoset polymer,
R^{c} is a reacted epoxy moiety, and
R^{d} is hydrogen or a reacted epoxy moiety or a phosphonate moiety coupled to at least one reacted epoxy moiety within the thermoset epoxy polymer.
Phosphonates or phosphonic acids are organic compounds containing —C—PO(OH)₂ or —C—PO(OR)₂ groups (wherein R is alkyl, aryl). They are not volatile and poorly soluble in organic solvents. For preparing polymers of the invention they can be integrated into the epoxy-based backbones by reactive incorporation through P—C bond formation with the epoxy resin.
The epoxy thermoset polymers of the invention can be prepared with many suitable structurally different phosphonates, for example with mono, bis, tris or oligo H-phosphonates, optionally bis-H-phosphonates, optionally pentaerythrityl bis-H-phosphonates, 2,4,8,10-tetraoxa-3,9-diphosphaspiro[5.5]undecane, 3,9-dioxide, or an oligomer of pentaerythrityl bis-H-phosphonates.

The epoxy thermoset polymers of the present invention will vary depending on the epoxy reactants, the phosphonates, hardeners, curing agents, etc. For example, epoxy thermoset polymers of the present invention may be

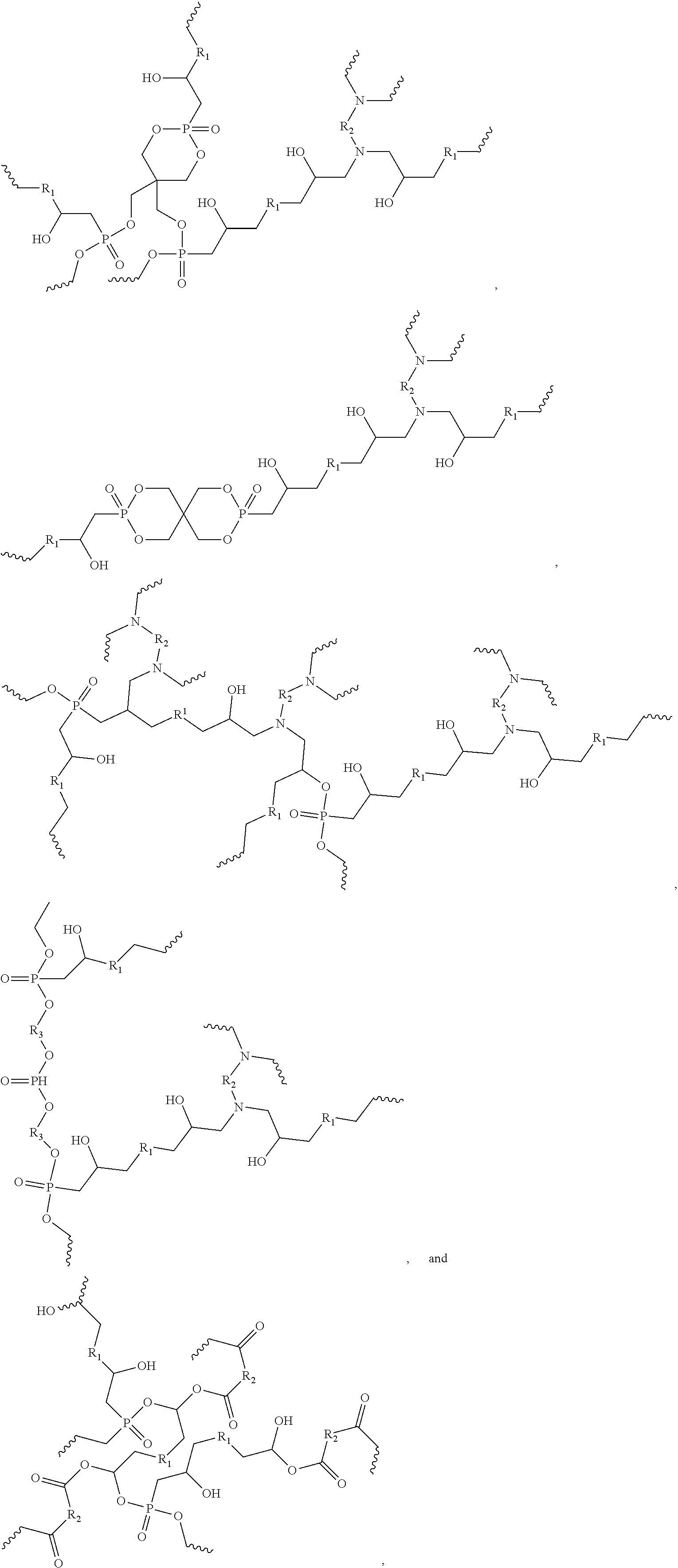

wherein
the wave lines form part of the epoxy thermoset polymer network, R₁ are epoxy resin moieties, R₂ are epoxy hardener moieties, optionally amine or carboxylic epoxy hardener moieties, R₃ are polyols, and x=0 to 10, optionally 1 to 8 or 2 to 6.

The epoxy thermoset polymers of the invention may be prepared by many different epoxy reactants, for example epoxy moieties, optionally R₁ above, that are selected from the group consisting of bisphenol-based, bisphenol-A-based, aliphatic, cycloaliphatic, aromatic, bis, tris and multifunctional, halogenated, Novolak, glycidylamine-based epoxy resins and other epoxy resins based on the epoxy of formula (III)

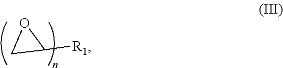

wherein R₁ is optionally selected from the group consisting of

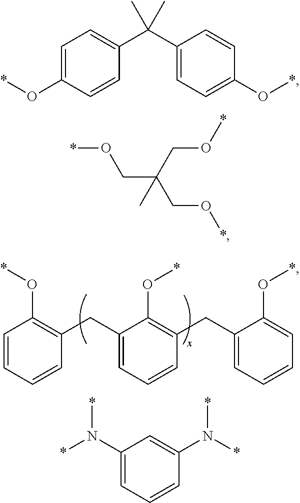

wherein
* are bonding points
n is 2 to 4; and
x is 0 to 4.

For curing, i.e. hardening or polymerizing epoxy resin reactants, epoxy catalysts, (for homopolymerization), optionally anionic catalysts such as tertiary amines or imidazoles, or cationic catalysts such as a boron trifluoride complex, and hardeners are used, optionally hardeners selected from the group consisting of amines, optionally polyfunctional primary amines, anhydrides, alkali, phenol and thiol based epoxy thermoset hardeners. Further optional epoxy embodiments for practicing the present invention are selected from epoxy formula (IV)

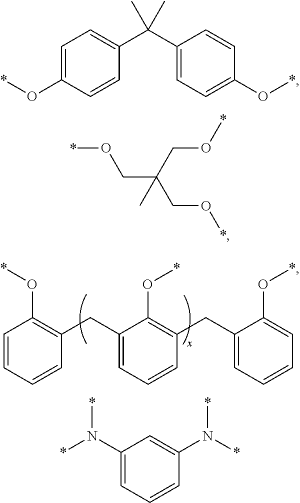

wherein n is 2 to 4; and x is 0 to 4.

For preparing the thermoset epoxy polymer of the invention the epoxy hardener moiety, optionally R₂, is optionally selected from the group consisting of amine epoxy hardeners, carboxylic epoxy hardeners, anhydride epoxy hardeners, acid anhydride epoxy hardeners, and acid epoxy hardeners, optionally selected from the group of amine epoxy hardeners according to formula (V)

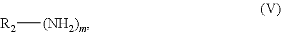

wherein R₂ is selected from the group consisting of

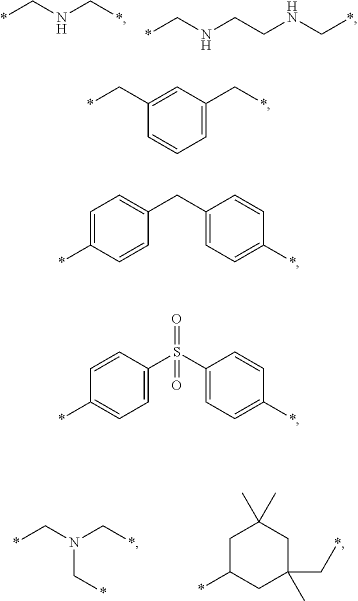

and
m is 1, 2 or 3, * indicates the attachment bond of R₂,
optionally selected from the group of acid anhydride and carboxylic acid hardeners, optionally

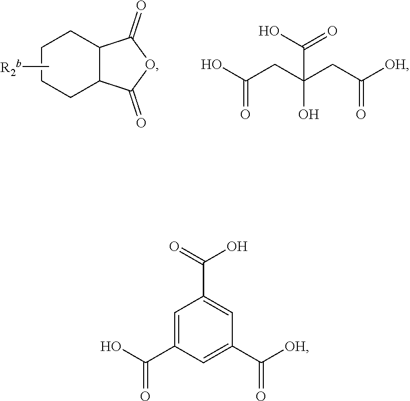

wherein R_{2b} is H or CH₃.

A suitable catalyst for preparing the polymer of the present invention is, for example, an organic base, e.g. 1,8-diazabicyclo[5.4.0]undec-7-en or 1,5,7-triazabicyclo[4.4.0]dec-5-en) to form epoxy thermoset phosphonate P—C bonds within the epoxy thermoset chain. A base catalyst will promote deprotonation of H-phosphonates to nucleophiles and attack the electrophilic C of the oxirane C—O bond along with the ring opening to form P—C bonds.

In a further aspect, the present invention is directed to a method for preparing an epoxy thermoset polymer of the invention, for example, comprising the steps:
(a) providing epoxy resin reactants;
(b) adding, mixing and reacting an H-phosphonate, optionally selected from the group consisting of mono, bis, tris and oligo H-phosphonates, pentaerythrityl bis-H-phosphonates, 2,4,8,10-tetraoxa-3,9-diphosphaspiro[5.5]undecane, 3,9-dioxide, and oligomers of pentaerythrityl bis-H-phosphonates, with the epoxy resin reactants, optionally with organic base, optionally with 1,5,7-triazabicyclo[4.4.0]dec-5-en) (TBD), optionally heating, optionally heating to 50 to 90° C.;
(c) adding, mixing and reacting at least one epoxy thermoset hardener to the composition of (b);
(d) heating the composition, optionally heating from 50 to 200° C., optionally from 80 to 160° C., optionally for 1 to 20, optionally 4 to 10 hours.
   wherein optionally a transesterification catalyst can be added in step (b), (c) or (d) (vitrimer formation), optionally heating to activate transesterification.

Even though the transesterification catalyst can be added at any time, it optionally activates transesterification upon heating. For example, the transesterification can be added in step (b) but actually activates transesterification in step (d) upon heating the composition.

Step (b) is the oxirane ring opening and phosphonate introduction step to form a covalently bonded phosphonate-epoxy thermoset polymer with P—O and P—C bonds within the epoxy thermoset polymer chain. Step (c) is the resin hardening, wherein the polymer chains are at least partially connected with each other, optionally with an amine-based hardener as exemplified herein. Step (d) is a curing step, optionally in molds of various shapes, at higher temperatures or stepwise at different temperatures. As the skilled person appreciates the steps of hardening and curing may be performed in one or subsequent steps depending on the conditions (temperature, time, pH, catalysts, etc.) chosen.

The term H-phosphonate as used herein is meant to indicate mono- and diesters of phosphonic acid (H₃PO₃), also referred to herein as H-phosphonates, which are four-coordinate compounds and contain a characteristic H—P═O structural motif, which governs their unique chemical properties, with the structure (A) as below:

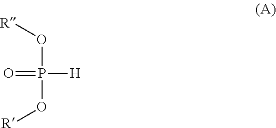

In one embodiment of the method of the invention the transesterification catalyst is added in step (b) or (c), optionally in step (b). Preferred transesterification catalysts may be, e.g. 1,8-diazabicyclo[5.4.0]undec-7-en, 1,5,7-triazabicyclo[4.4.0]dec-5-en, or other transesterification catalysts, like zinc acetate.

Without wishing to be bound by theory it is understood that transesterification of the phosphonate components can occur simultaneously during the hardening and/or curing process, as free hydroxyl groups are been released constantly, which promotes a high degree of curing conversion.

For the method of the invention the epoxy resin reactants are selected, for example, from the group consisting of bisphenol-based, optionally bisphenol-A-based, aliphatic, cycloaliphatic, aromatic, bis, tris and multifunctional, halogenated, Novolak, bio- and glycidylamine-based epoxy resins.

A curing agent for use in the method of the invention is optionally selected from the group consisting of aliphatic or aromatic amines, carboxylic anhydrides, carboxylic acids, and polyols.

In a further aspect the present invention is directed to an epoxy thermoset polymer of the present invention obtained or obtainable by a method described herein.

The thermoset epoxy polymers of the invention are especially useful for fire safe materials, optionally fire safe polymers or composites, fire safe textiles, re-processable polymers or composites, damage reparable polymers, composites or coatings, 3D-printable polymers and composites, extrudable polymers and composites. These materials are fire-retardant, even more fire-retardant than phosphate-based fire retardant thermosets and can be reprocessed or damage-repaired upon heating to allow for transesterification without leaking and with high environmental stability.

For this reason, products prepared from epoxy thermoset polymers of the present invention are improved in many ways. For example, the invention also encompasses products selected from the group consisting of fire safe materials, optionally fire safe polymers or composites, fire safe textiles, re-processable polymers or composites, damage repairable polymers, composites or coatings, 3D-printable polymers and composites, extrudable polymers and composites comprising a thermoset epoxy polymer according to any of claims 1 to 9.

In the following, the invention will be illustrated by way of representative examples and figures, none of which limit the scope of the invention beyond the appended claims.

### FIGURES

FIG. 1 shows (a) a one-pot, two-step synthesis procedure of reactive spirocyclic bisphosphonate TDPSD cured flame retardant epoxy resin EP-TDPSDs. (b) Solution phase ³¹P NMR (³¹P-(¹H)) of spirocyclic bisphosphonate TDPSD in DMSO-d⁶, (c) solid state ³¹P NMR of EP-TDPSD-4P, and (d) FTIR spectra of epoxy resin blank (EP-bl), EP-TDPSD-2.5P, EP-TDPSD-4P and TDPSD.

FIG. 2 shows (a) TGA and (b) DTG data of spirocyclic phosphonate TDPSD covalently incorporated EP-TDPSDs thermosets under nitrogen atmosphere, 10° C. min⁻¹, (c) DSC thermograms of the EP-TDPSDs, (d) TGA of EP-Vitrimer 2 (EP-TDPSD-6P) with varied amount of catalyst TBD, (e) stress relaxation curves of EP-Vitrimer 2 at 10% strain under different temperatures up to 200° C., where the stress (α) is normalized by the initial stress (σ₀). The dotted line indicates the point at σ/σ₀=1/e (=0.3679), and (f) fitting of the relaxation times r to the Arrhenius plots as a function of inverse temperatures.

FIG. 3. (a) shows the schematic and chemical structure of a dynamic network; (b) Optical images of a piece EP-TDPSD-6P reconnected/healed at 160° C. for 5 mins after broken in the middle (circle); (c) Recyclability of the EP-TDPSD-8P vitrimer using hydraulic hot pressing for 5 min at varied temperatures under 6 MPa pressure.

FIG. 4 shows EP-TDPSD coated and blank MDF samples measured with 5 minutes continuous ignition using Bunsen burner (butane gas), with (a) the maximal back temperature of the wood plate measured by IR camera, (b) optical images of the coated and untreated MDF samples after 5 mins ignition, and (c) cross section of the EP-TDPSD-2.5P coated MDF plate. All samples were located with distance to the blue flame~50 mm (flame temperature~1100° C.).

FIG. 5 shows SEM images of the residual chars for EP-bl outer surface (a, b, and c), flame-retardant thermosets EP-TDPSD-1.2P outer surface (d, e, and f), and EP-TDPSD-1.2P inner surface (g, h, and j) at difference magnification obtained from the UL-94 tests.

FIG. 6 illustrates the proposed decomposition mechanism of EP-TDPSDs (according to DIP-MS and TG-FTIR).

FIG. 7 illustrates the synthesis of aliphatic vitrimers (left) and aromatic vitrimers (right) through a one curing step of pre-functionalized epoxy resin. Bisphenol A diglycidyl ether (DGEBA), isophorone diamine (IDA—aliphatic hardener), 4,4′-Methylenedianiline (MDA—aromatic hardener). Pre-Vitrimer 1 was formed through the reaction of DGEBA with diethylphosphite.

FIG. 8 Graph (a) shows non-isothermal DSC cures of the VALI-5P resin, and graph (b) shows a Kissinger's plot to determine activation energy (Eα); Table (c) shows the fitted slope of the linear fit representing Eα, and graph (d) shows the second curing curves under two heating rates.

FIG. 9 shows the FTIR-ATR spectra for EARO, VARO-3P, VARO-5P, VARO-5P_R and for their reagents: MDA, DEP and DGEBA.

FIG. 10 shows the FTIR-ATR spectra for EALI, VALI-3P, VALI-5P, VALI-5P_R and for their reagents: IDA, DEP and DGEBA.

FIG. 11 (a) to (d) are graphs showing TGA curves for EARO, VARO-3P and VARO-5P recorded under N2 atmosphere.

FIG. 12 shows photographs of snapshots of the UL94 tests for (left) VALI-3P and the residue after burning, and (right) VARO-3P with pictures of char residues after the UL94 vertical burning tests.

FIGS. 13 (a) and (b) are graphs showing heat release curves of VARO and VALI samples obtained by PCFC measurement.

FIG. 14 (a) to (f) are graphs showing (a) the heat release rate (HRR), (b) the average rate of heat emission (ARHE), (c) the total smoke production (TSP) measured using cone calorimeter for the VARO-3P, and (d-f) the corresponding results for the VALI-3P.

FIG. 15 illustrates (a) the thermal-mechanical recyclability of the ideal vitrimers, and (b) the actual recyclability of VALI-5P, VALI-3P, VARO-5P and VARO-5P using hydraulic hot pressing for 20 min at varied temperatures under a pressure of 6 MPa.

FIGS. 16 (a) and (b) characterize composite demonstrators using VALI-6P as polymer matrix; FIG. 16 (a) is a graph showing the heat release rate (HRR), FIG. 16 (b) is a graph showing the average rate of heat emission (ARHE).

FIGS. 17 and 18 are reaction schemes illustrating the synthesis of oligomeric phosphites and the modification of epoxy vitrimers using oligomeric phosphites.

FIGS. 19a and 19b are DSC graphs illustrating the dynamic curing process of Example 9, including the Penta-oligomer with DGEBA epoxy resin and Iso-oligomer with DGEBA epoxy resin under different heating rates.

FIGS. 20a and 20b illustrate the TGA curves of the Penta-oligomer cured vitrimer and the lo-oligomer cured vitrimer of the compounds of Example 9.

FIGS. 21a, 21b and 21c illustrate the UL94 vertical burning results for Penta-oligomer cured vitrimer and the lo-oligomer cured vitrimer of the compounds of Example 9.

### EXAMPLES

### Materials

Pyridine, diphenylphosphite, 1,8-diazabicyclo[5.4.0]undec-7-en (DBU) and 1,5,7-triazabicyclo[4.4.0]dec-5-en (TBD) from Sigma-Aldrich (CH). Bisphenol A resin (Epikote™ Resin 827) and isophorone diamine (IPDA, Epikure™ Curing Agent 943) from Hexion Specialty Chemicals GmbH, DE.

### Examples 1 to 5

### Example 1—Synthesis of Two Epoxy Thermoset Polymer Structures (1) and (2)

(1) pentaerythrityl bis-phosphonate via P—C bonds covalently networked epoxy thermoset:

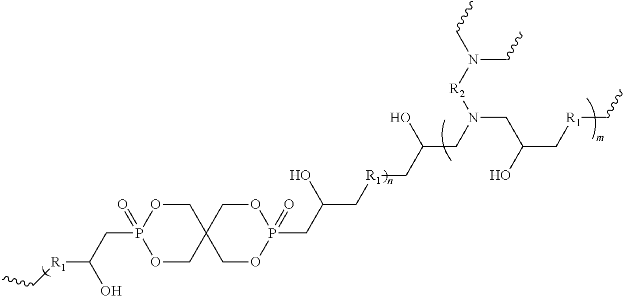

wherein
R¹=epoxy backbones, including Bisphenol-based, Novolac backbones, or any epoxy resin backbones

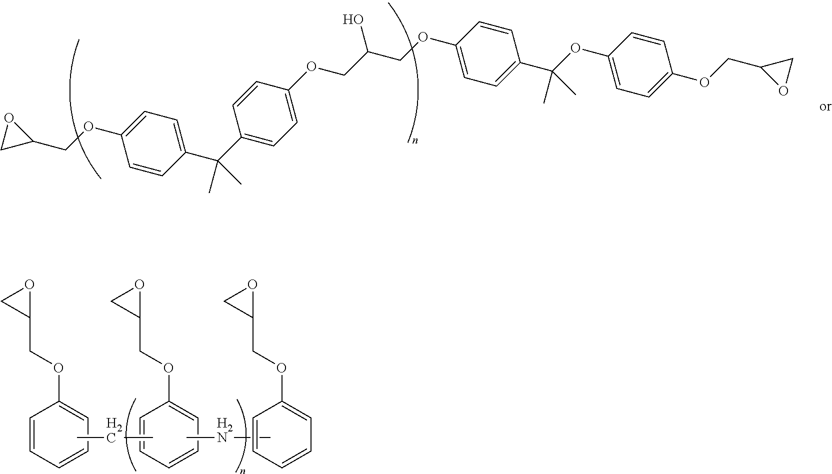

R₂=amine hardener backbones, including aliphatic and aromatic amine hardeners

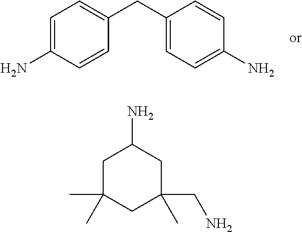

(2) Phosphonate networked thermosets via direct P—C bonds and P—O bonds simultaneously connected to the thermoset macromolecule).

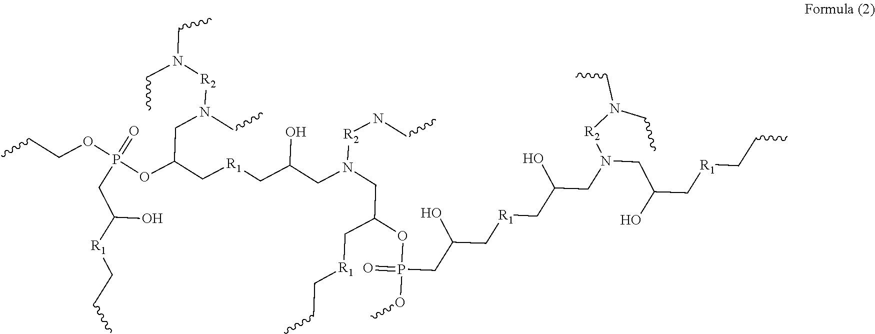

wherein R₁ and R₂ the same backbones as in (1) above

Epoxy thermoset polymers with formula (1) were obtained via a one-pot and two-step process. Commercially available DGEBA epoxy systems were modified by the addition of 2, 4, 8, 10-tetraoxa-3, 9-diphosphaspiro[5.5]undecane, 3, 9-dioxide (bis H-phosphonate) as reactive phosphorus moiety. First, the epoxy resin was reacted with bis H-phosphonate on the oxirane ring of epoxy. Subsequently, an aliphatic amine curing agent was used to cure the resin. The bis H-phosphite brought in sufficient associative dynamic covalent ester bonds (P—O) to the cross-linked thermoset; consequently, the transesterification reaction can be activated via heat to promote reprocessability of resulting epoxy thermosets.

Specifically, bisphenol A diglycidyl ether (DGEBA), a certain molar ratio of the reactive bis-H-phosphonate (TDPSD) and transesterification catalyst (Triazabicyclodecene, TBD) were mixed, and left at 80° C. for 2 h. Later, amine hardener was added to the mixture at room temperature and mixed vigorously for 5 min. Subsequently, the mixture was cured stepwise at 100° C. for 2 h, another 2 h for at 140° C., and final curing at 160° C. for 2 h.

(2) Epoxy thermoset polymers with formula (2) were obtained via a similar approach as above. Firstly, commercially available epoxies were partially reacted with diethyl/dimethyl phosphite with catalyst TBD at 80° C. for 5 h, and then amine hardeners were added into the pre-reacted mixture. Following a stepwise curing procedure at 100° C. for 2 h, another 2 h for at 140° C., and final curing at 160° C. for 2 h, the epoxy thermosets were cured to achieve heat resistance, flame-retardancy and reprocessability.

### Example 2—Synthesis of Bis Spiro-H-Phosphonate TDPSD

Bis spiro-H-phosphonate core TDPSD was synthesized via a transesterification/phosphonation approach. (see Schafer et al., Inorganic Chemistry 2018, 57 (18), 11662-11672; Lord et al., ChemistrySelect 2016, 1 (10), 2188-2191. A double neck round bottle flask (100 mL) was charged with pentaerythritol (3 g, 22.03 mmol) and a magnetic stir bar. The flask was cooled to 0° C. with an ice-bath, and connected to a dropping funnel with pyridine (30 mL) and diphenylphosphite (9.5 mL, 49.6 mmol). The mixture was slowly dropped into the pentaerythritol powder under nitrogen atmosphere, and the resulting mixture was stirred for 2 hours at room temperature. THF (60 mL) was injected into the flask via syringe, and the resulting suspension was vigorously stirred for 10 min which led to a white insoluble precipitates. The reaction mixture was filtered, and the THF solution was decanted. The crude intermediate was washed two times with small amounts of THF (2*10 mL), and resulting solid residue was dried under vacuum for 6 hours to obtain a white powder, the target product (TDPSD, yield 65%). The synthesis route and detailed characterization data are presented in the SI.

### Example 3—Preparation of TDPSD Covalently Incorporated Epoxy Resin EP-TDPSDs

The composition and acronyms of different thermosets synthesized herein are summarized in Table 1. In a representative process, bisphenol A diglycidyl ether (DGEBA), and certain molar ratios of the reactive bis spiro-H-phosphonate TDPSD (Table 1) were mixed and left at 80° C. for 2 h. Later, aliphatic amine (IPDA), and for vitrimers, transesterification catalyst TBD, were added to the mixture at room temperature and mixed vigorously for 5 min. Subsequently, the mixture was poured into different Teflon molds of different shapes and oven cured. A stepwise curing procedure at 100° C. for 2 h, another 2 h for at 140° C. and final curing (160° C./2 h) followed.

TABLE 1
The compositions of thermosets.

| | Bisphenol A | Isophorendiamine | | | |
|---|---|---|---|---|---|
| | resin | (IPDA, Epikure ™ | | | |
| | (Epikote ™ | Curing Agent | | | |
| Thermosets | Resin 827) | 943) | TDPSD | DBU | TBD |
| EP-bl | 1 | 0.5 | 0 | 0 | / |
| EP-TDPSD-1.2P | 1 | 0.45 | 0.1 | 0.005 | / |
| EP-TDPSD-2.5P | 1 | 0.40 | 0.2 | 0.01 | / |
| EP-TDPSD-4P | 1 | 0.35 | 0.4 | 0.02 | / |
| EP-TDPSD-5P | 1 | 0.30 | 0.5 | 0.025 | 0.05 |
| (Vitrimer 3) | | | | | |
| EP-TDPSD-6P | 1 | 0.2 | 0.7 | 0.035 | 0.05 |
| (Vitrimer 2) | | | | | |
| EP-TDPSD-8P | 1 | 0.15 | 0.8 | 0.04 | 0.05 |
| (Vitrimer 1) | | | | | |

### Example 4—Coating on Wood (Medium-Density Fibreboard)

Following the above mentioned thermoset preparation procedure, formulation EP-TDPSD-2.5P was used for coating application on medium-density fibreboard (MDF). The epoxy resin DGEBA (1 equivalent) was first reacted with 0.2 equivalent of bis spiro-H-phosphonate TDPSD (Table 1) at 80° C. for 2 h. Before applying the resin on MDF, 0.4 0.2 equivalent of aliphatic amine IPDA was added to the mixture at room temperature and mixed vigorously 5 minutes. Utilizing a thin film applicator (BGD 218, automatic film applicator, Guiged precise instrument), the resin mixture was applied homogenously on the surface of MDF with a sample gap of 1 mm. The coated MDFs were cured under 100° C. for 2 h, another 2 h for at 140° C. and followed by final curing (160° C. for 2 h). Finally, the coated MDFs were cut into 10×10 cm² for further testing.

### Example 5—Characterization of Epoxy Thermoset Polymers

### 5.1 NMR Spectra

NMR spectra were recorded using a Bruker AV-Ill 400 spectrometer (Bruker BioSpin AG, Switzerland). ¹H and ¹³C chemical shifts (6) were calibrated to residual solvent peaks. The ³¹P chemical shifts were referenced to an external sample with neat H₃PO₄ at 0.0 ppm.

Solid-State NMR (ssNMR) measurements were performed on a Bruker Avance III HD 400 spectrometer (Rheinstetten, Germany) employing a 4 mm CP MAS probe. Approximately 50 mg of pulverized thermoset sample was filled in teflon inert for ssNMR analytics. Spectra were recorded at a frequency of 161 MHz for 31P and 100 MHz for 13C, at 10 kHz spinning, respectively, at room temperature. Spectra were referenced to (NH₄)H₂PO₄ for ³¹P (0 ppm) and for ¹³C using adamantine (+38.5 ppm) as an external standard.

### 5.2 Phosphorus Content

Phosphorus content of the composites was measured using the inductively coupled plasma optical emission spectrometry method (ICP-OES), on a 5110 ICP-OES (Agilent Switzerland AG, Basel, CH) apparatus. Sample preparation for ICP-OES consisted of mixing 100 mg of a sample with 3 mL HNO₃, followed by digestion using a microwave.

ATR-FTIR spectra were recorded with a Bruker Tensor 27 FTIR spectrometer (Bruker Optics, Ettlingen, DE), using a single reflection attenuated total reflectance (ATR) accessory with 4 cm-1 resolution, 32 scans and OPUS™ 7.2 software. In case of residues from fire tests, samples were collected from the burnt places and mixed properly prior to analysis.

### 5.3 Thermogravimetric Analysis (TGA)

TGA was performed on a NETZSCH TG 209 F1 instrument (NETZSCH-Gerstebau GmbH, Selb, DE) under N₂ and air with a flow of 50 mL/min. Temperature range from 25 to 800° C. at a ramp of 10° C./min was used for the analysis.

### 5.4 Differential Scanning Calorimetry (DSC)

DSC was performed on the DSC 214 Polyma instrument (NETZSCH-Gerstebau GmbH, Selb, DE) at a heating rate of 10° C./min (20 to 200° C.), under a N₂ flow (50 mL/min) by running two repeating cycles. The glass transition temperature (T_{g}) was determined by using the “tangent method” as the meeting point of tangents to the curve, traced on the baseline and the peak side, on the low-temperature peak side.

### 5.5 UL 94 Vertical Burning Tests

UL 94 vertical burning tests of the thermosets flammability were assessed according to IEC 60695-11-10, with sample size of 13×125×3 mm³.

### 5.6 Cone Calorimetry

Cone calorimetry (Fire Testing Technology, East Grinstead, London, UK) was performed with an irradiative heat flux of 35 kW/m2 (ISO 5660 standard) on a specimen (100×100×3 mm³) placed horizontally without any grids. Parameters such as heat release rate (HRR), peak of heat release rate (pHRR), average specific extinction area (SEA), total smoke release (TSR), total heat release (THR) and the final residue were recorded.

### 5.7 Direct Inlet Probe Mass Spectroscopic (DIP-MS)

DIP-MS measurements were carried out using a Finnigan/Thermoquest GCQ ion trap mass spectrometer (Austin, TX, USA) equipped with a DIP module. DIP-MS was useful to detect possible volatile products. Nearly 1 mg of composite sample taken in a quartz cup located at the tip of the probe was inserted into the ionization chamber. Measurements were performed at an ionization voltage of 70 eV, temperature of the ionic source of 200° C., <10-6 mbar pressure and probe temperature ramp 60° C./min from 30 to 450° C.

5.8 Scanning Electron Microscope (SEM) and Energy Dispersive X-Ray Spectra (EDX) SEM and EDX were recorded using a Hitachi S-4800 scanning electron microscope (Tokyo, Japan) equipped with Inca X-sight device from Oxford Instruments (Tokyo, JP). During SEM measurements, acceleration was maintained at 2 kV and with emission current of 10 DA at a working distance of 8 mm. For EDX measurements, acceleration was maintained at 20 kV and with emission current of 15 mA at a working distance of 15 mm.

### 5.9 Rheological Tests

Rheological tests were carried out on an Anton Paar Physica 301 MCR rotational rheometer (AT). All tests were performed with a parallel plate fixture (plate diameter of 25 mm and gap of 1 mm). The EP-Vitrimer sample was thermally processed into (1 mm plates) using a hot press at 140° C. The plates were then dried in a vacuum oven overnight at 80° C. prior to the measurements. Stress relaxation experiments were conducted after a 10 min temperature equilibration (from 140 to 200° C.), a 5% strain step was applied and the stress was monitored over time. A constant normal force of 10 N was applied during all the measurements to ensure a good contact of the material with the parallel plates.

### Results and Discussion

Result 1—Synthesis of Thermosets Containing Phosphonate Moieties and their Chemical and Physical Characterization

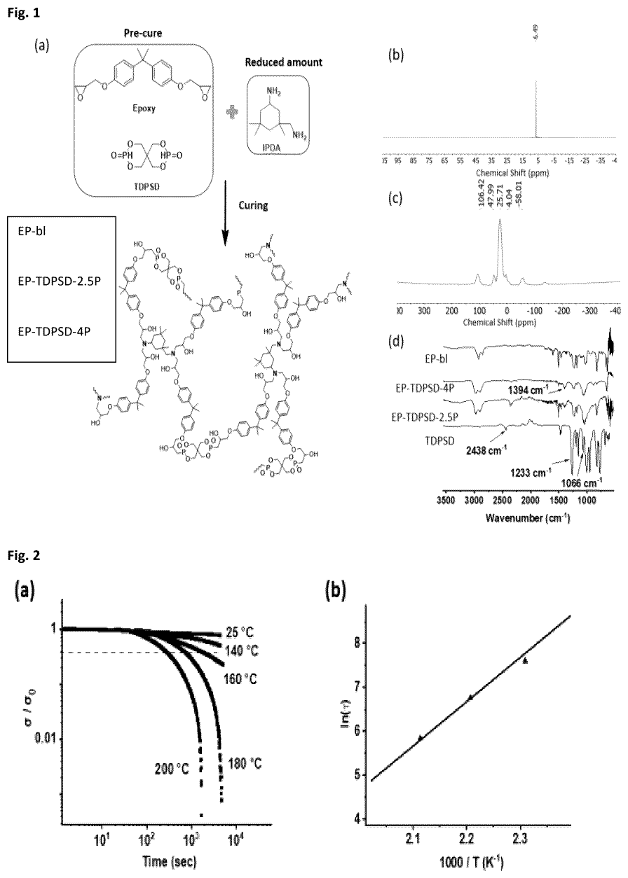

A one-pot and two steps procedure was developed to synthesize multifunctional transparent epoxy thermoset with varied TDPSD contents (FIG. 1). The chemical structures of the modified epoxy resins were confirmed by NMR spectroscopy (¹H, ¹³C, ³¹P, ¹H—¹H COSY and ¹H—¹³C HMQC), FTIR spectroscopy and element analysis. The ³¹P NMR (³¹P—(¹H)) spectra of TDPSD and the solid state ³¹P NMR of the modified thermoset are displayed in FIG. 1.

From FIG. 1b, the decoupled ³¹P NMR spectra of TDPSD shows a single peak at 6.49 ppm. In order to confirm the full conversion of TDPSD and the formation of P—C bond, solid state ³¹P NMR of the EP-TDPSD-4P epoxy powder was performed which confirms the disappearance of the P—H signal at 6.49 ppm. The presence of new signals centered at 25.71 ppm can be assigned to P—CH₂— decoupling (FIG. 1c). This confirmed the not hydrolysable P—C bond formation and the covalent incorporation of the P moiety into the thermoset network. Unlike phosphoester linkages (P—O), the linkage of the phosphorus moiety via a robust P—C bond to the resin network offers hydrolysis stability and prevents its potential leaching during usage and recycling. In addition, the presence of phosphorus in the thermoset network offers fire protection. The reactive P—H bond of TDPSD allows direct covalent linkage to the epoxy, which can result in optimized fire performance at lower P loadings compared to a non-reactive approach. To further characterize the thermoset network, ¹³C CP MAS ssNMR spectroscopy was performed on EP-TDPSD-2.5P and EP-TDPSD-4P samples.

The FTIR spectra of TDPSD, epoxy resin blank (EP-bl), the TDPSD cured epoxy resin EP-TDPSD-2.5P and EP-TDPSD-4P are shown in FIG. 1. The absorption peak around 2438 cm⁻¹ as shown in FIG. 1d, is attributed to the P—H bond in TDPSD, disappears in EP-TDPSD-2.5P and EP-TDPSD-4P. This disappearance illustrates the full reaction of the TDPSD with the epoxy matrix. The absorption peaks P—O—C appears at 1066 cm⁻¹ for the modified thermoset. The peaks around 1607 cm⁻¹, 1510 cm⁻¹ and 1233 cm⁻¹ correspond to the aromatic ring of the epoxy structure and P═O of the TDPSD phosphorus moiety. Most importantly, the formation of the P—C bond is confirmed by the appearance of an absorption band at 1394 cm⁻¹, which is absent in TDPSD and EP-bl. Thus, it is clear that bis-H-phosphonate TDPSD was covalently incorporated into the epoxy matrix through the one pot, two steps synthesis method.

### Results 2—Fracture Morphology of the Novel Epoxy Thermoset Polymers

The morphology comparison of the fractured surfaces of EP-TDPSD-2.5P and EP-bl were investigated by scanning electron microscopy. The smooth surface of fractured pure epoxy resin display regular cracks, attributing to its relatively poor fracture resistance as reported for pure epoxy thermosets. EP-TDPSD-2.5P showed a relative homogeneous micro fracture morphology. Unavoidably, large scale bubbles are formed in the one pot, two steps co-curing procedure, fortunately without significant phase separation. The general uniform fractured structure of EP-PTODP-2.5P indicates a homogeneous distribution of the reactive TDPSD in the cured epoxy matrix. This observation indicates that the reactivity of TDPSD with epoxy resin was fully utilized through the one-pot and two-steps process by reacting TDPSD with epoxy beforehand and then fully cured with hardener.

### Result 3—Thermal Property

Highly cross-linked materials, such as epoxy thermosets, have a softening temperature T_{g} (the glass transition temperature), which determines its specific application. The origin of the softening via the glass transition is due to increased free volume of chains upon heating beyond T_{g}. Along with softening, the materials eventually show fluidity upon further heating. Conventional epoxy thermosets do not show fluidity upon heating because of its highly cross-linked network structure formed from stable bonds and restricted free chain motion. As a consequence, fully cross-linked thermoset materials lose their recyclability due to the formation of a permanent network structure. However, the introduction of associative dynamic covalent P—O ester bonds in the thermoset enable their potential recyclability without losing thermal stability. Given the circumstances that sufficient ester bonds (P—O) are already existing in the EP-TDPSDs epoxy thermoset, it was predicted that the epoxy network could repair via transesterification reaction under external stimuli when defects arise. Normally, the recycling temperature is located above the T_{g} and the initial decomposition temperature (Tₒₙₛₑₜ). Therefore, the T_{g}s and Tₒₙₛₑₜs was investigated for determining the recycling temperature ranges with the increased amount of TDPSD.

The T_{g}s of EP-TDPSDs were evaluated by DSC, which is generally ascribed to the segmental motion of the polymeric networks, and T_{g} is determined by the degree of freedom for the segmental motion, cross-linking and entanglement constraints, and the packing density of the segments. TDPSD is bifunctional in nature and reacts with the epoxy resin to form linear macromolecules, which promotes segmental motion and inhibits cross linking. Therefore, all EP-TDPSD thermosets exhibited a lower T_{g} than EP-bl (155° C.), as shown in Table 2, due to the dynamic free chain motion with higher TDPSD content.

The thermal stabilities of the EP-TDPSDs with varying P contents were evaluated by TGA under an inert atmosphere. The novel epoxy thermoset polymers exhibit good thermal stability, the temperatures of 5% mass loss (Tₒₙₛₑₜ) for all samples are above 240° C. Although Tₒₙₛₑₜ decreases for the EP-TDPSD thermosets (Table 2), compared to 351.7° C. for EP-bl., EP-bl shows one-step mass loss in the temperature range of 300-450° C., while the EP-TDPSDs exhibit apparently two or more thermal decomposition stages in the same range until 370° C. with an additional shoulder that extends over a range of approx. 100° C. Additionally for EP-TDPSDs, a small decomposition step (approx. 9 wt %) appears at 455° C. The data obtained above indicate the optimal reprocessing temperature, which lies between the glass transition temperature and the initial decomposition temperature (230° C.>Tᵣₑ>94° C.).

The transesterification catalyst, TBD, has negligible effect on the thermal stability of the EP-TDPSD thermosets. Even though the addition of TDSPC to the thermoset matrix catalyzes the decomposition to lower temperatures, a larger amount of char residue is formed at temperatures above 400 C. In comparison of 5.8% char residue for EP-bl, EP-TDPSD-2.5P has almost three times (16.7%, Table 2) char residue, and EP-TDPSD-6P has significantly 5 times (28.1%) char residue. This indicates the potential condensation phase driven good flame retardancy of EP-TDPSDs.

### Result 4—Recyclability and Reparability

Considering sufficient associative dynamic phosphonate ester (P—O) bonds exist in the EP-TDPSDs, transesterification reaction occurs at elevated temperature above T_{g}. And the transesterification induced dynamic bond-exchange within the network is a unique property and indicator for re-processable thermosets, which can be monitored by rheological stress relaxation. When heated up the internal stresses can be released and thus the viscosity will be reduced. Among the series of epoxy thermoset designed herein, EP-TDPSD-6P revealed great stress-relaxation at high temperatures (more than 140° C.), meanwhile there was negligible stress-relaxation at room temperature. FIG. 2a presents the stress-relaxation curves for EP-TDPSD-6P at various temperatures, where the stress (α) normalized by the initial stress (σ₀) was plotted as a function of time. It follows a simple Arrhenius law with an activation energy of ~75 kJ/mol K as shown in FIG. 2b. The temperature-dependent transesterification is in the network, which indicates the potential re-processability of the material.

TABLE 2
Thermal analysis results obtained from DSC and TGA
measurements for epoxy thermosets with increasing
amount of TDPSD under nitrogen atmosphere.

| | | Tₒₙₛₑₜ^{b} | Tₘₐₓ^{c} | Residual yield at |
|---|---|---|---|---|
| Samples | T_{g}(° C.) | (° C.) | (° C.) | 800° C. (w %) |
| EP-bl | 155.6 | 351.7 | 369.5 | 5.8 |
| EP-TDPSD-1.2P^{a} | 148.6 | 303.6 | 340.3 | 12.0 |
| EP-TDPSD-2.5P | 139.3 | 295.7 | 340.5 | 16.7 |
| EP-TDPSD-4P | 131.7 | 300.8 | 342.4 | 24.0 |
| EP-TDPSD-5P | 113.4 | 257.3 | 337.2 | 24.6 |
| (EP-Vitrimer 3) | | | | |
| EP-TDPSD-6P | 107.1 | 239.6 | 332.1 | 28.1 |
| (EP-Vitrimer 2) | | | | |
| EP-TDPSD-8P | 94.2 | 236.8 | 331.2 | 29.7 |
| (EP-Vitrimer 1) | | | | |

^{a}Abbreviation of the spirocyclic phosphonate co-cured expoxy resin.
^{b}Onset decomposition temperature, at which the thermoset undergoes 5 wt % weight loss.
^{c}Characteristic temperature, at which maximum rate of weight loss occurs.

To demonstrate the healing capability of the synthesized vitrimers the surface of samples were scratched with a razor blade and exposed to 160° C. in a pre-heated oven for 5 min, the scratches disappeared, and the sample became smooth. SEM analysis confirmed the detailed microstructure reparability of the TDPSD co-cured EP-TDPSDs. The scratched epoxy surface appear as a coarse, fractured and granular crack under SEM. After exposure to heat the crack gets smoother and consecutive. To demonstrate full healing capacity of EP-TDPSD-6P thermoset when exposed to external mechanical damage (FIG. 3a), a piece of EP-TDPSD-6P was completely broken in two pieces (FIG. 3b). The broken pieces were put together and exposed in a pre-heated oven under 160° C. for 5 min. The broken parts could rejoin fully without additional force or treatment (FIG. 3b) demonstrating its superior healing capacity. The above observed macroscopic flow and reparability could demonstrate the intrinsic malleability and healability of the EP-TDPSD-6P, which is in the end mediated through the rearrangement of the thermoset network via phosphonate transesterification.

Thermal-mechanical recycling process is illustrated in FIG. 3c. In order to recycle the EP-TDPSD-6P bulk plate, it was grinded into opaque white powder via cryo ball milling. Then the fine powder is collected and evenly spread in a rectangular-shaped metal mold. The set of samples were hot-pressed at 150° C. and 160° C. at 6 MPa pressure for 5 min. Afterwards the powder was fused into transparent and integrate plates again (FIG. 3c). From the rheological studies, the modulus of the epoxy thermoset at the recycling temperature was observed as quite low. Therefore, upon heating the powder liquefied and fused together under hot press. These epoxy thermoset powders can be straightforwardly molded into desired shape by hot compression. The recycling circle can be repeated up to three times without dramatic mechanical property decrease. The dynamic P—O bonds allow the chain interpenetration and formation of new crosslinks. Under same re-/processing conditions the vitrimer thermosets with higher P content (more P—O bonds) gave homogenous and integrated re-pressed plates. which is in agreement with of the predicted transesterification mechanism.

### Results 5—Fire Performance and Potential Application of the Epoxy Thermoset Vitrimers

From the TGA experiments, it was observed that the char residuals at 790° C. for EP-TDPSD-1.2P, EP-TDPSD-2.5P and EP-TDPSD-4P increased significantly to 12.0%, 16.7% and 24.0%, compared to a meagre 5.8% for EP-bl. This can be attributed to the addition of the reactive TDPSD which can promote the char formation and decrease the mass loss of epoxy during the main stage of thermal decomposition. In particular the pentaerythritol component of TDSP is known to be an excellent char former. The weight loss of the vitrimers at 370-470° C. is attributed to the further decomposition of char formed in the initial stage, which is consistent with the result of earlier reports.

The epoxy thermosets with and without reactive spirocyclic phosphonate TDPSD were subjected to vertical flame spread test (UL 94) to assess their flammability. Vitrimer with 2.5% of P-content (EP-TDPSD-2.5P) achieved a UL 94-VO classification. The right concentration of TDPSD in the epoxy thermosets matrix is crucial to obtain UL 94-VO classification, as EP-TDPSD-1.2P containing only 1.2 wt % P burns partially and does not achieve any classification.

### Results 6—Coating Application on Medium-Density Fibreboard (MDF)

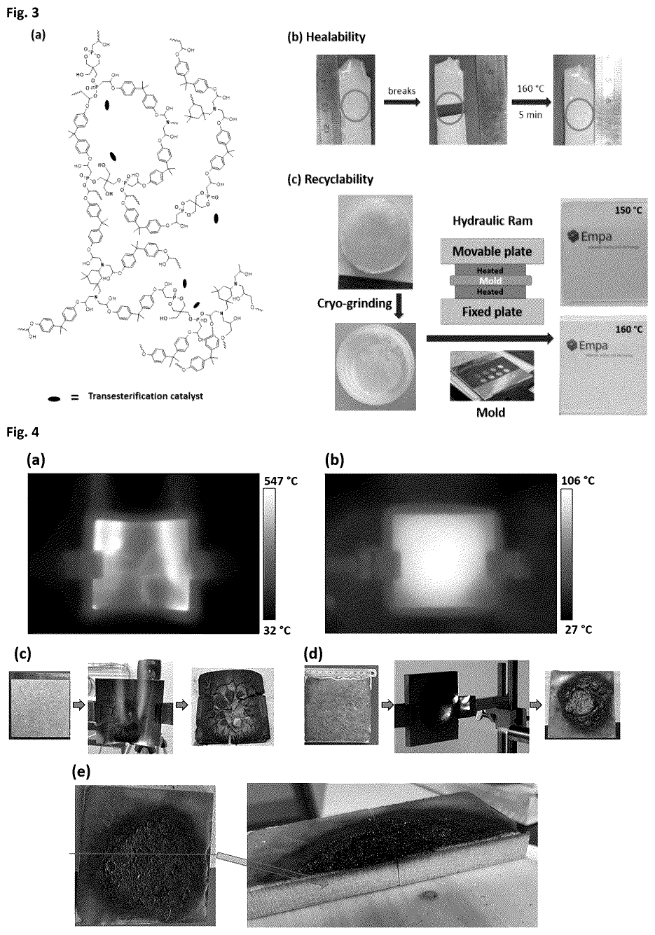

The demonstrated exceptional fire-resistance capability of the intumescent EP-TDPSDs films make them a suitable thin coating candidate for inflammable material protection, especially in the transportation and building industries. Based on the excellent fire inhibition and char foaming property in the small-scale fire test discussed above, 1 mm EP-TDPSD-2.5P coating was applied on the surface of MDF samples, and investigated for their fire resistance and heat isolation properties, as shown in FIG. 4.

Even after five minutes of continuous ignition with bunsen burner (flame temperature more than 1100° C.), the EP-TDPSD-2.5P coated MDF plate did not catch fire with its backside temperature reaching a maximum temperature of 106° C. (FIGS. 4b and d), while the MDF blank burned completely with backside temperature reaching almost 550° C. (FIGS. 4a and c). On removal of surface intumescent char, the underlying MDF matrix was found to retain its integrity (FIG. 4e). EP-TDPSDs has a perspective for flame-retardant surface treatments, including the potential for industrial implementation. The weight loss of the MDF blank is about 74%, in contrast, only 6.8% was observed for the EP-TDPSD-2.5P coated MDF plate.

### Results 7—Fire Inhibition Mechanism

The decomposition mechanism of composites and the influence of the various additives on the released gases was investigated in detail by mean of TGA-IR and DIP-MS analyses. It was observed that EP-TDPSD-2.5P produces in general much less volatile products than EP-bl, the volatile products from EP-bl increase with temperature, while EP-TDPSD-2.5P produces the most gaseous products after the Tₒₙₛₑₜ and then decreases gradually after 400° C. At 340° C. (Tₘₐₛ) EP-TDPSD-2.5P generates the most decomposed gaseous products and afterwards the gaseous products drops down. Unlike the EP-bl, it emits increasing amount of gaseous decomposition products when temperature increases.

At 350° C. the infrared absorption peaks at 885 cm⁻¹, about 931 cm⁻¹ and 966 cm⁻¹ were detected for EP-bl, which were attributed to alkene species and NH₃, respectively. Such peaks with low intensity were observed for EP-TDPSD-2.5P. Instead peaks at 746 cm⁻¹ and 1056 cm⁻¹ correspond to P—O containing species. Peak around 1343 cm⁻¹ attributing to P—C containing were observed. With increased temperature, the sharp peaks around 1510 cm⁻¹ corresponding to aromatics and aliphatic volatile components (3000-2840 cm⁻¹) in EP-bl is significantly suppressed for EP-PTODP-2.5P. In contrast, carbonyl peaks (1790-1680 cm⁻¹) observed for EP-bl generally disappeared for EP-TDPSD-2.5P after 400° C. Furthermore, all nitrogen containing volatile species were very minor or invisible for EP-TDPSD-2.5P, as peaks at 1605 cm⁻¹, 1363 cm⁻¹ and 775⁻¹ assigned to N—O species, 1440⁻¹, 1458⁻¹, 2090⁻¹ and 2246 cm⁻¹ for C—N containing highly toxic species were absent or considerably reduced. At the same time, for EP-TDPSD-2.5P peaks corresponding to H₂O were inconspicuous (fussy peaks around 3750-3500 cm⁻¹ and 2000-1200 cm⁻¹).

Simultaneously, DIP-MS analysis indicated that the decomposition of the EP-TDPSD-2.5P produced a large amount of phosphorous species from 200 to 400° C., whereas lower relative abundance of the volatile compounds was observed for the EP-bl (Figure S14). The formation of major fragments like PO radical (m/z 47) and 3-methyloxetane radical (m/z 71) initiates after 200° C. already, while the HPO₂ radical (m/z 64) and other P-containing fragments evolved after 300° C. These radicals in the early gas phase confirm the decomposition of TDPSD, which results in a strong flame inhibition action of TDPSD from the early stage. In air PO radical can act in the gas phase and consume the high energy H· and OH· species in a flame by recombining with them and interrupting the combustion chain reaction, which leads to fire self-extinguishing or favors flame inhibition. The above results of gaseous pyrolysis products were quite consistent with the TGA-IR results obtained in nitrogen atmosphere. The degradation of EP-TDPSD-2.5P forms P-containing radicals, which can seize other active free radicals in the gas phase and restricted burning.

### Results 8—Analysis of the Char Residue

It is understood that phosphorus-based intumescent flame retardants play very critical part in the condensed phase, and therefore, exploring the structure, morphology, and chemical composition of the char residue after the fire tests can contribute to the understanding how TDPSD works in the flame retardant epoxy matrix. The surface morphology and elemental composition of EP-TDPSD-1.2P after combustion was characterized using scanning electron spectroscopy (SEM, FIG. 5) and energy dispersive X-ray spectrometry (EDS) mapping.

Compared to the compacted and fissured char residue of EP-bl (FIGS. 5a, b and c), EP-TDPSD-2.5P left a distinguish char with inner and outer layer differences. The residual outer layer (FIGS. 5d, e and f) exhibited a coherent and sealed appearance, while the inner structure (FIGS. 5g, h and j) was intumescent and multi-porous. The closed outer layer could act as an effective physical barrier and lower gas flow. Besides, this porous char structure would prevent the heat transfer and the escape of volatiles. Therefore, it was assumed that the inner layer was efficiently isolating heat and outer layer was blocking oxygen when EP-TDPSDs catch fire. EDX showed a unified P distribution on the char residue according to element mapping and overlapping, which indicated also that the covalent incorporation of TDPSD with epoxy was homogenous. These results together with the char yields in TGA experiments confirmed that the covalent incorporated TDPSD phosphonate units in EP-TDPSDs play a major role in the formation of char during thermal degradation.

The char residues of EP-bl and EP-TDPSD-2.5P after fire tests were also characterized by FTIR to investigate the residue functional groups after decomposition. The broad absorption band at around 1592 cm⁻¹, 1486 cm⁻¹, 1447 cm⁻¹ represents the C═C stretching vibration of polyaromatic carbons. This strong absorption band indicated that the incorporation of TDPSD into the epoxy thermoset enabled formation of sufficient aromatic component in the char. From FT-IR of EP-TDPSD-2.5P char residual 1202 cm⁻¹ and 1168 cm⁻¹ of P═O, at 1088 cm⁻¹, 992 cm⁻¹ and 901 cm⁻¹ P—O were observed, The absorption peak appearing at 973 cm cm⁻¹ was attributed to —P(═O)—O—. It indicated that the condensed phase of EP-TDPSDs contained significant residue rich in phosphorus.

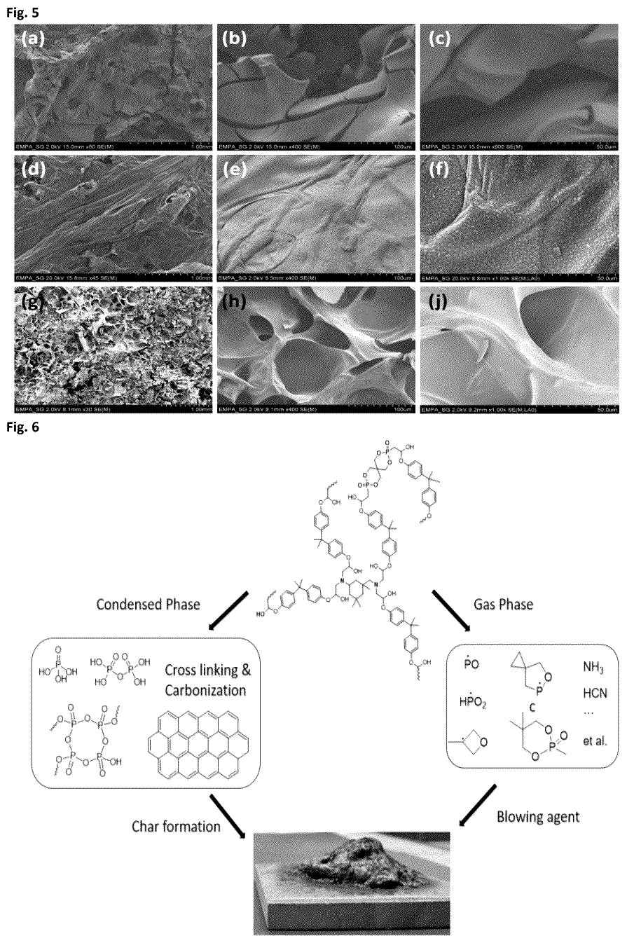

These results demonstrated that the flame retardancy of TDPSD modified epoxy thermosets was not due to one single mechanism but rather a complex combination of mechanisms, including the gas phase mechanism and the condensed phase mechanism (FIG. 6) both caused by the covalent incorporated phosphonate units. In the combination of gas-phase and condensation phase actions TDPSD acted as co-curing reagent by replacing an accountable amount of carcinogenic amine hardener, and played an important role in improving the thermal stability and flame retardancy of cured EP-TDPSDs, and reduced the production of toxic nitrogen containing evolving gases.

### Results 9—Summary and Conclusions

Novel and improved epoxy thermoset polymers were presented with not only excellent re-processable/recyclable properties but also proven inherent fire protection. And a representative one-pot/two step-process with a varied combination of bisphenol epoxy resin, reactive spirocyclic phosphonate TDPSD and the representative amine hardening agent IPDA was evaluated for the synthesis of these epoxy thermoset polymers. The covalent incorporation of reactive P—H containing TDPSD into the epoxy resin replaced the amine-hardener IPDA in a 2:1 ratio. With increasing TDPSD concentration the dynamic ester bonds containing epoxy thermoset polymers obtain excellent non-flammability, as demonstrated, e.g. for EP-TDPSD-2.5P, optical transparency, reparability after scratching and cutting, and additional recyclability for EP-TDPSD-8P.

For EP-TDPSD-2.5P, TDPSD did improve the thermal stability and flame retardancy of the cured epoxy thermoset polymer via combination of gas-phase and condensation phase of actions, reduced toxic nitrogen containing evolving gases production, thus providing a scalable coating application on MDF for demonstration purposes. The representative agent TDPSD promoted a remarkable reduction up to 48% in the heat release rate (HRR) values, and introduced non-flammability to the MDF plate due to the outstanding gas-phase action and intumescent char structure through isolating heat and oxygen more efficiently. Pyrolysis evolved gas (Py-GC MS and TGA-IR), thermal and fire analysis was used to propose the combined mode (gas phase and char) of action of TDPSD in the fire performance improvement of the EP-TDPSDs epoxy thermoset system. The functional polymer EP-TDPSD-2.5P is one of many potential candidates for fire- and heat-resistant applications in electronic and microelectronic fields with more safety and excellent performance.

And the thermo-mechanical recycling method shown for the vitrimer reformation by compression of heat and pressure demonstrated that TDPSD promoted the reparability and recyclability of the epoxy thermoset polymers EP-TDPSD-6P and EP-TDPSD-8P. Without wishing to be bound by theory, it seems that the reversible P—O ester bond exchange reactions provide for a versatile transesterification that rearranges the network topology while keeping cross-linking and functionality of the covalent links.

### Examples 6 to 8

In Examples 6 to 8 the vitrimer thermosets of the invention were further varied and modified to obtain and demonstrate more non-limiting embodiments of the invention and to characterize the economic and feasible vitrimers that combine good fire performances and inherent reprocessability. Several phosphonated phosphorus-containing epoxy resins (epoxy-based vitrimers) were synthesized and then analyzed. Using a one-pot and two-step process, the epoxy resin was functionalized using diethyl phosphite, and then the pre-functionalized epoxy was cured using two amine hardeners to obtain the final vitrimer thermosets. The material was characterized, and flame retardancy as well as material reprocessability were investigated.

### Example 6—Material Synthesis

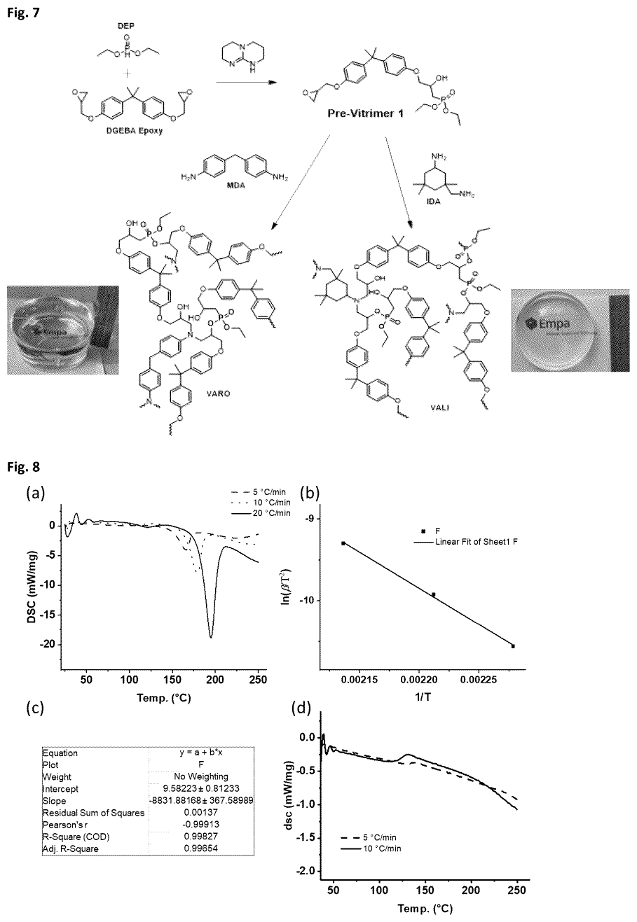

In a first step, a commercially available epoxy resin (Bisphenol A diglycidyl ether, DGEBA) was modified with a phosphorus-based compound (Diethylphosphite, DEP), using 1,5,7-triazabicyclo[4.4.0]dec-5-ene (TBD) as a base to catalyze the reaction. In the second step, the modified epoxy resin (pre-Vitrimer 1, see FIG. 7) was cured using two different amine-based curing agents, i.e., one aromatic (MDA) and the other aliphatic (IDA). Different concentrations of the phosphorus compound were used following the formulation in Table 3.

The aliphatic and the aromatic hardeners required for two slightly different curing procedures. Synthesis of VARO (AROmatic Vitrimer): MDA curing agent, commercialized as solid, was manually ground into fine powder, then it was added to the Pre-Vitrimer 1 (see FIG. 7). Then, the resulting mixture was kept at 70° C. in order to let the powder dissolve. Once the hardener was completely dissolved, the solution was poured in different molds. Then, the system was left overnight (~16 h) at 70° C. in a vacuum oven at 100 mbar. Afterwards, the temperature was increased to 100° C./2 h, to 130° C./2 h and in the end, there was a final increase to 160° C./2 h. Synthesis of VALI (ALIphatic Vitrimer): IDA curing agent, available as liquid on the market, was directly mixed to Pre-Vitrimer 1 and immediately poured into the molds. The curing process was then carried out at the same vacuum pressure and timing used for the aromatic hardener, with a slight difference in the first step. The curing was performed for 16 h/60° C., for 2 h/100° C., for 2 h/130° C. and finally for 2 h/160° C. VARO and VALI samples were prepared at two different P concentrations (around 3, 5 wt. %) as reported in Table 3.

A detailed characterization of the thermal and fire behavior of the final products was made by comparison of the innovative samples with the conventional epoxy resin (pristine material). Besides, the reprocessability of the samples was evaluated. Grinding and hot-pressing were utilized as thermomechanical recycling method for recycling the epoxy vitrimer. The recycled materials were characterized using thermal and chemical methods to compare with the pristine materials, thus to determine the recyclability of the materials.

Reprocessability was achieved through dynamic transesterification via the implementation of sufficient covalent adaptable networks made with phosphonate esters. The abundant hydroxyl groups formed after the epoxy ring opening and the ester group from DEP are the key players of this reaction.

TABLE 3
Formulation of the control sample
and the TDPSD cured thermosets.

| | DGEBA | DEP | MDA | IDA | TBD | P* |
|---|---|---|---|---|---|---|
| | (mol/ | (mol/ | (mol/ | (mol/ | (wt. | (wt. |
| Sample | mol) | mol) | mol) | mol) | %) | %) |
| EARO | 1 | / | 0.5 | / | / | 0 |
| VARO-3P | 1 | 0.5 | 0.1875 | / | 5 | 2.8 |
| VARO-5P | 1 | 1.3 | 0.0875 | / | 5 | 5.2 |
| EALI | 1 | / | / | 0.5 | / | 0 |
| VALI-3P | 1 | 0.5 | / | 0.1875 | 5 | 3.0 |
| VALI-5P | 1 | 1.3 | / | 0.0875 | 5 | 5.7 |

*Phosphorus (P) content (wt. %) in the samples was determined by ICP-OES analysis.

### Example 7—Curing Process

The non-isothermal curing kinetics of VALI-5P were studied by DSC. The Kissinger's method (eq 1) was used to obtain the apparent activation energy during the curing process (see also Wang et al., J. of Applied Polymer Science 1999, 74 (7), 1635-1645; Cai et al., Thermochimica Acta 2008, 473 (1), 101-105.)

$$- In ( q / {T}^{2} ) = {E}_{a} / RT - In ( AR / {E}_{a} ) \qquad ( 1 )$$

where q is the heating rate, T is the exothermic peak temperature, Eₐ is the activation energy, R is the gas constant, A is the pre-exponential factor. DSC curves (FIG. 8a) of curing at heating rates of 5, 10, and 20° C./min in air atmosphere were prepared. FIG. 8b reveals the plots of ln(q/T²) versus 1/Tₚ based on Kissinger's equation for the VALI-5P systems, and the Eas calculated from the slope of the linear fitting plots are concluded in Table 4. Enthalpy of curing (−ΔH) in J/g for the epoxy compositions as measured at different heating rates and temperatures of the exothermic maximum on curing curves as measured at different heating rates, are listed in Table 4. As calculated, VALI-5P presented slightly higher Eₐ (73.4 kJ/mol) comparing to reported DGEBA-IPDA systems, which is indicative of the sequential reaction of the transesterification reaction of phosphonate ethoxyl groups with the beta-hydroxyl groups after epoxy ring opening.

TABLE 4
Enthalpies of curing (ΔH) of VALI-5P and the maximal
exothermic temperatures under different heating rates.

| Heating rate | Enthalpy of curing | |
|---|---|---|
| (° C./min) | (−ΔH) J/g | Tₘₐₓ (° C.) |
| 5 | 136.6 | 165.7 |
| 10 | 140.3 | 180.1 |
| 20 | 169.0 | 194.9 |

### Example 8—Characterization

### FTIR-ATR

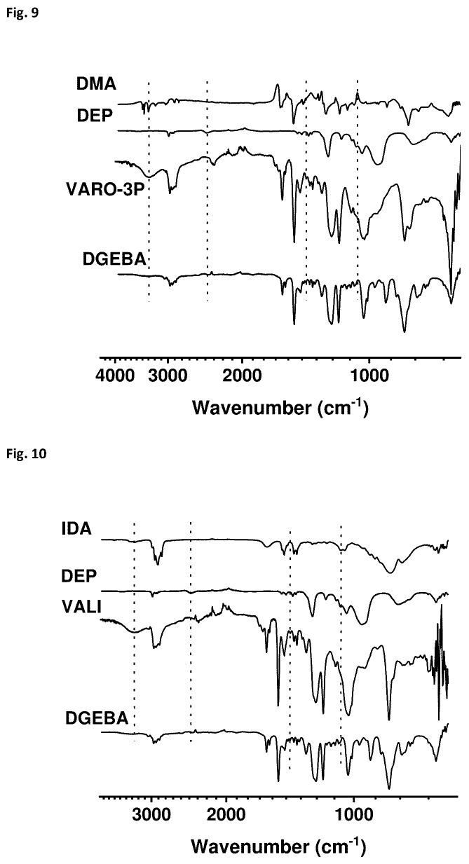

FTIR-ATR tests were carried out to investigate the chemical composition features of EALI, VALI-3P, VALI-5P, EARO, VARO-3P and VARO-5P samples and reprocessed ones (VALI-5P_R and VARO-5P_R). FTIR-ATR was also performed on raw materials (MDA, IDA, DEP and DGEBA resin) used for the synthesis of blank systems and vitrimers, in order to identify the main characteristic bands of these chemicals. FIGS. 9 and 10 show FTIR-ATR spectra of aromatic and aliphatic samples, including reactants involved for their preparation. All the obtained spectra were normalized to the strong absorption bands at 1607 and 1510 cm⁻¹, related to the C═C bonds of the benzene rings present in the epoxy resin structure, which are not expected to change after the curing reaction. The absence of peak at 910 cm⁻¹ in the spectra of cured samples confirms the completeness of the crosslinking process, which proves that all the oxirane rings of DGEBA epoxy chains have reacted through curing or transesterification. As DGEBA matrix was used for the preparation of all the samples, its peculiar peaks located at 1230 cm⁻¹(ν_{C—O}) and 2980 cm⁻¹ (ν_{C—H}) are present in the spectra of epoxies and vitrimers (see Li et al., Composites Communications, 2021, 25, 10075.) The presence of phosphate structures in vitrimers is responsible for the appearance of the bands at 1066 cm⁻¹(ν_{P—O—C}), related to P—O—C linkages, and at 1320 cm⁻¹(ν_{P—C}), attributed to the P—C groups, which are absent in the spectra of pristine thermosets. By comparing spectra of vitrimers with the one of DEP, it is possible to observe that the peak at 2433 cm⁻¹ (ν_{P—H}) disappears in the case of vitrimeric systems, due to the reaction between P—H functionalities and oxirane rings. The chemical structure of DEP contains P═O moieties, therefore the spectra of vitrimers show the presence of related peak at 1225 cm⁻¹(ν_{P—O}) (see Daasch and Smith, Analytical chemistry 1951, 23 (6), 853-868). These results support the occurrence of the reaction between the DGEBA epoxy matrix and DEP in vitrimers, though the NMR measurements reveal that not all the P—H functionalities are consumed, which means that the conversion is not full.

### Thermogravimetric Analysis (TGA)

TGA analysis under N₂ atmosphere was performed to investigate the thermal stability and pyrolytic degradation behavior of EARO, VARO-3P, VARO-5P, EALI, VALI-3P and VALI-5P samples and reprocessed ones (VARO-5P_R, VALI-5P_R and VALI-5P_R2). TGA results are listed in Table 5, where VALI-5P_R2 represents VALI-5P system after two cycles of physical recycling by hot pressing.

As shown in Table 5 and FIG. 11, EARO and EALI decompose through a main degradation step at around 380° C. and 330° C., respectively (see also Shim et al., Polymer Journal 1998, 30 (2), 73-77; Chrysanthos et al., Polymer 2011, 52 (16), 3611-3620). It is reported that at the first decomposition temperature (T_{5%}, Table 5.1), epoxy resin starts releasing some volatile products, namely acrolein, acetone and allyl alcohol (see also Venezia et al., ACS Applied Polymer Materials 2021, 3 (11), 5969-5981). On the other side, at the maximum weight loss rate (FIG. 11a-b), the degradation of unmodified epoxy systems forms high molecular weight products and more complex phenolic compounds. TGA data display that both EARO and EALI produce a significant amount of char between 50° and 700° C., which keeps stable even at higher temperatures (see also Venezia et al., ACS Applied Polymer Materials 2021, 3 (11), 5969-5981). Unlike pristine epoxies, vitrimers decompose in two steps (FIG. 11), as already observed in the literature for other vitrimeric systems (see also di Mauro et al., ACS Sustainable Chemistry & Engineering 2020, 8 (20), 7690-7700; Azcune et al., European Polymer Journal 2021, 148, 110362).

TABLE 5
TGA analysis of the listed samples under N₂ atmosphere.
T_{5%} is the temperature at which 5% of weight loss is observed, whereas
Tₘₐₓ₁ and Tₘₐₓ₂ are the temperatures at which the maximum
weight loss rate is observed in the DTG-derivative-curves.
Residual masses at 700° C. are also reported.

| | | | | Residue |
|---|---|---|---|---|
| | T_{5%} | Tₘₐₓ₁ | Tₘₐₓ₂ | (wt %) at |
| Sample | (° C.) | (° C.) | (° C.) | 700° C. |
| EARO | 367 | 387 | / | 16 |
| VARO-3P | 278 | 351 | 429 | 24 |
| VARO-5P | 199 | 329 | 429 | 30 |
| VARO-5P_R | 252 | 357 | 430 | 35 |
| EALI | 333 | 368 | / | 8 |
| VALI-3P | 246 | 325 | 422 | 15 |
| VALI-5P | 188 | 328 | 405 | 24 |
| VALI-5P_R | 239 | 323 | 410 | 25 |
| VALI-5P_R2 | 285 | 325 | 414 | 29 |

### Fire Performance

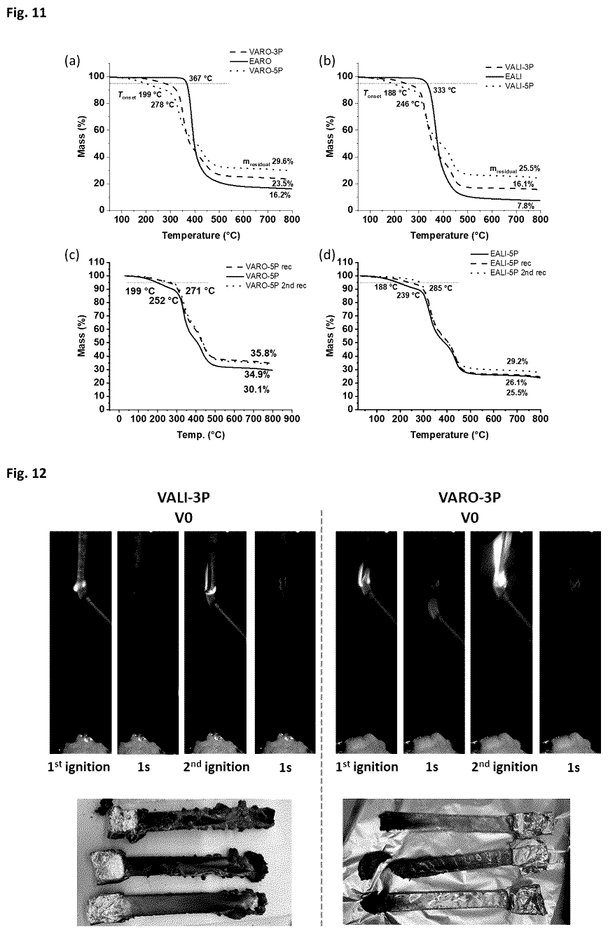

The results of the UL94 tests and residues left after the fire tests are presented in FIG. 12. Both EARO-3P and EALI-3P thermosets with around 3% P content achieved UL 94-VO classification. The flame of both thermosets extinguished within 2 seconds after two ignitions. The UL94 vertical flammability test does not only allow the evaluation of the flammability of the obtained formulations, but also provides information regarding the fire retardant mechanism of the investigated FR additives in epoxy. After ignition, EALI-3P emitted more smoke than EARO-3P.

To investigate their decomposition behavior, vitrimers and blank epoxy thermosets were subjected to PCFC (Pyrolysis combustion flow calorimeter analysis). PCFC is a non-flaming calorimetry test that allows a controlled pyrolysis of the specimens followed by an oxidation at high temperature of the volatiles, therefore the combustion does not occur as a continuous process in air condition. The main results of PCFC (THR, HRC and pHRR) measurements performed on the aromatic samples (EARO, VARO-3P and VARO-5P) are summarized in Table 6. The results indicate that the presence of a phosphorus-containing phase in the vitrimeric systems results in a significant reduction of HRC, THR (up to 37%) and pHRR (up to 66%), with respect to the unmodified epoxy. The reduction of HRC and THR might be ascribed to the condensed phase action exerted by the char produced during the degradation of vitrimers, while the release of phosphorus-based inhibitors slows down the oxidation of the carbonaceous residue, resulting in lower values of pHRR compared to the pristine resin.

TABLE 6
Pyrolysis Combustion Flow Calorimeter data for the
aromatic and aliphatic amine cured thermosets.

| | THR | HRC | pHRR |
|---|---|---|---|
| Sample | (kJ/g) | (J/g-K) | (W/g) |
| EARO | 29 ± 0.1 | 575 ± 30 | 566 ± 22 |
| VARO-3P | 22 ± 0.7 | 295 ± 32 | 291 ± 32 |
| VARO-5P | 20 ± 0.5 | 299 ± 42 | 284 ± 40 |
| EALI | 30 ± 0.3 | 522 ± 16 | 513 ± 14 |
| VALI-3P | 24 ± 0.8 | 478 ± 78 | 471 ± 75 |
| VALI-5P | 20 ± 0.1 | 382 ± 24 | 374 ± 23 |

THR = Total Heat Release.
HRC = Heat Release Capacity.
pHHR = peak of Heat Release Rate.

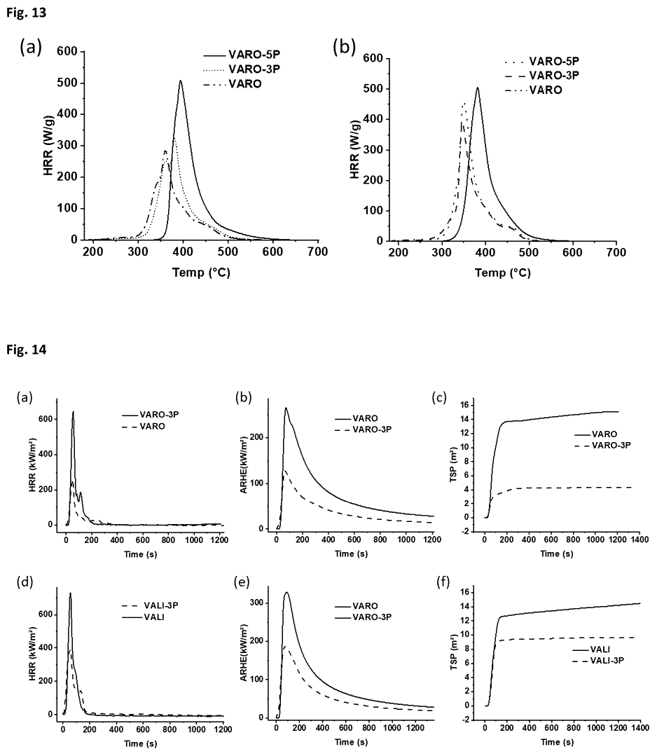

Based on that, the lowest values of pHRR and THR were recorded for the sample with the highest content of phosphorus (VARO-5P) (see Sonnier et al., Polymer Degradation and Stability 2016, 134, 186-193; Ménard et al., Polymer Degradation and Stability 2015, 120, 300-312). In agreement with the TGA results, FIG. 13 shows that the both aromatic and aliphatic vitrimers start decomposing at lower temperatures compared to the neat epoxy, owing to the less fixed characteristic of the polymer matrix (see also Menard et al., Polymer Degradation and Stability 2015, 120, 300-312; Vahabi et al., Coatings 2021, 11).

Also, due to the presence of the phosphorus-containing phase, VARO-3P and VARO-5P are characterized by a lower temperature at which the peak of the heat release rate occurs compared to pristine epoxy. EARO exhibits narrow and sharp heat release peak in the HRR curve, due to a large amount of heat generated in a very brief period of time (FIG. 5.16) On the other side, VARO-3P and VARO-5P show broad and flattered HRR curves, since a longer time is required to spread over the heat release (see also Bifulco et al., Materials & Design 2020, 193, 108862). PCFC measurements were also performed on samples (EALI, VALI-3P and VALI-5P) cured with IDA aliphatic curing agent. Table 6 summarizes the main results of the PFCF analysis. Like the aromatic systems, the aliphatic ones show a linear reduction of pHRR, THR and HRC as the content of phosphorus present in the matrix increases, as shown in the FIG. 13b.

As previously observed for the aromatic vitrimers, FIG. 13b shows that VALI-3P and VALI-5P decompose at lower temperatures compared to the neat epoxy thermoset. However, aliphatic vitrimers and blank aliphatic epoxy are all characterized by narrow and sharp heat release peaks in the HRR curves, which means that the decomposition of VALI-3P and VALI-5P occurs in a short time range just as the neat epoxy. These differences in terms of fire behavior between aliphatic and aromatic systems are mainly due to the used curing agent. It is reported in the literature that aromatic hardeners allow the preparation of thermosets with higher thermal stability and lower flammability compared to the aliphatic ones (see also Bifulco et al., Composites Part C: Open Access 2020, 2, 100022).

In addition, cone calorimeter tests (FIG. 14) showed that after ignition the heat release rate (pHRR) of VARO quickly increases to the peak value of 647 kW/m² (pHRR). Whereas, the pHRR value of VARO-3P was only 262 kW/m². The presence of phosphonated unites has also a strong influence in reducing the pHRR of VALI-3P from 708 kW/m² to 391 kW/m² (FIG. 14d). The maximal average of the rate of heat emission (MARHE) reduced also 52% and 43% for VARO-3P and VALI-3P, respectively. In terms of the total smoke production (TSP) showed significant reductions (FIGS. 14c and 14d).

### Recyclability

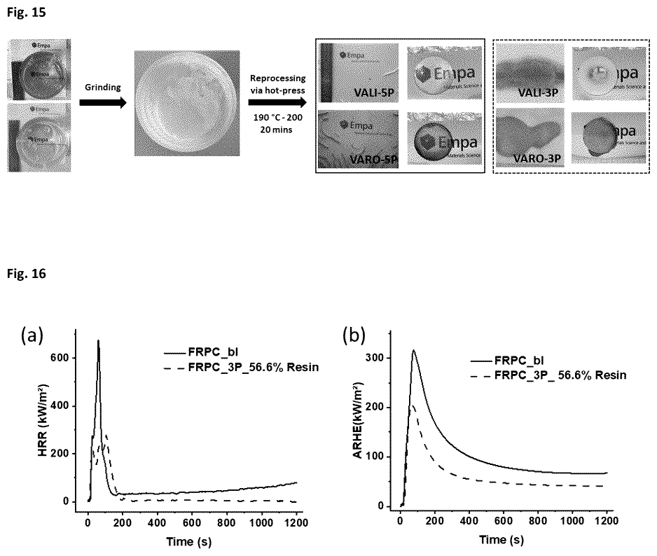

The thermomechanical recycling process is illustrated in FIG. 15. In order to recycle the cured materials, they were ground into opaque white powders via cryo ball-milling (see also Feng et al., ACS Applied Materials & Interfaces 2019, 11 (17), 16075-16086). Then the fine powder was collected and evenly distributed in differently shaped metal molds. The set of samples were hot-pressed around 200° C. at a pressure of 6 MPa for 20 min. This process enabled that the powder fused into solid transparent plates again (FIG. 15b). Physical recycling of VARO-3P and VALI-3P was performed, but the resulting samples were characterized by no fully-reacted zones, which were still in the form of solid powder. This behavior can be explained by the low content of phosphorus and thus low P—O ester bonds, which leads to a non-efficient and non-homogeneous network rearrangement. This means that the amount of dynamic transesterification reactions in the phosphorus-containing phase is not enough to obtain a homogeneous and satisfying physically recycled sample. Otherwise, other aspects to optimize are the process conditions of the hot-pressing. For example, higher temperatures or longer processing time could be used to obtain better quality samples (see also Yu et al., International Journal of Mechanical Sciences 2021, 201, 106466).

The P—O ester bonds allow the dynamic exchange reaction, chain interpenetration and formation of new crosslinks. Under similar re-processing conditions the thermosets with higher P contents (more P—O bonds) could be easily pressed into homogenous plates again (VARO-/VALI-5P), which is in agreement with the predicted transesterification mechanism These results indicate the dependence of reprocessability on the concentration of the dynamic phosphonate esters. Therefore, when better recyclability is required, higher P contents should be given. Meanwhile, the thermal stability and glass transition temperature might be altered.

The recycling circle of VARO-/VALI-5P can be repeated up to three times without dramatic thermal property decrease (FIG. 15b, the round plates). Even slight delayed thermal degradations were observed as well after three times of grinding and hot-press.

### Demonstration on FRPCs

Preliminary trials on fiber reinforced polymer composites were carried out to demonstrate the use of such material in composite application. The EALI and vitrimer VALI-6P were selected for demonstration. As shown in FIG. 16, composites with three lays of flax fiber ply were fabricated using hand-lay-up method at room temperature, and cured in the oven following same curing procedure for the thermoset materials, 2 h/100° C., for 2 h/130° C. and finally for 2 h/160° C. Cone calorimetry tests were carried out to characterize the thermal behavior during combustion. The HRR, MARHE, THR and the pHRR of the composites with around 3% P showed significant decreases, comparing to the control composites without any modification.

### Summary on Examples 6 to 8

Also examples 6 to 8 demonstrate phosphonated thermosets of the present invention with inherent flame retardancy and good reprocessability and recyclability, which are introduced by the phosphonate moieties simultaneously. Using the one-pot and two-step process, tuning varied ratios of DGEBA resin, reactive phosphite and two hardeners, the transparent multifunctional thermosets has been synthesized. The phosphonate ester covalent adaptable networks (CANs) of the covalently networked phosphite unites enable not only enhanced fire protection but also render the thermoset compounds of the present invention recyclable. Thermosets with different phosphor concentrations were prepared, a concentration of 3% P was adequate to achieve high flame retardancy and 5% phosphor was sufficient for thermomechanical reprocessability and relative high glass transition temperature (124° C.).

### Example 9—Epoxy Vitrimer Modification

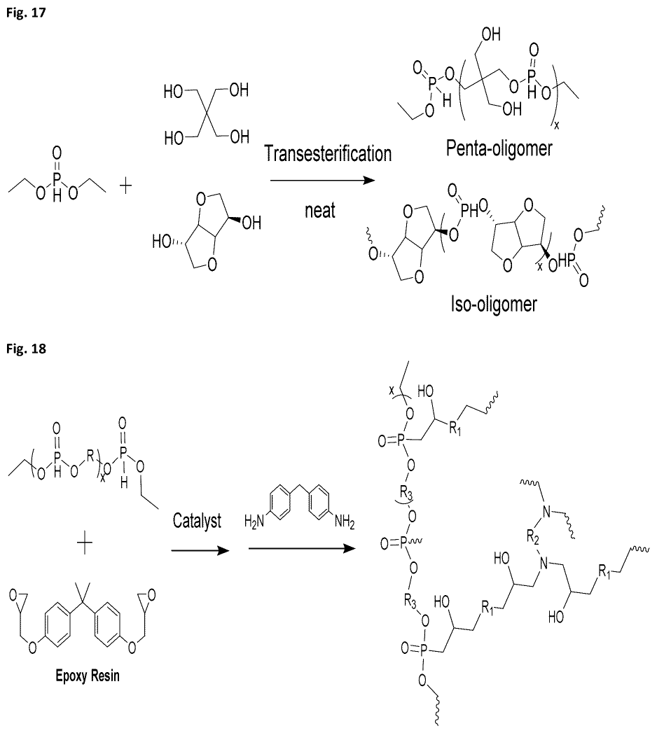

Oligomeric phosphites (see FIG. 17) were synthesized to obtain the phosphonated epoxy vitrimers (see FIG. 18), which did not only incorporate the phosphorus moieties for inherent fire protection but also created more dynamic bonds which can be cleaved during a recycling and healing step. The oligomeric phosphite monomers offer different physical, thermal and chemical properties owing to the variation of the molecular weight and building blocks of the phosphites (diols and polyols).

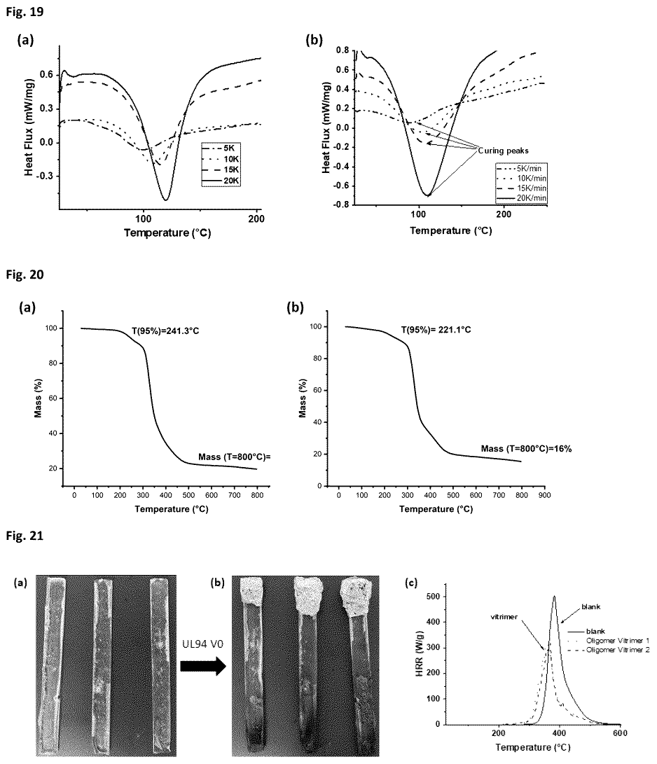

The curing process with the two oligomer phosphites was investigated using DSC (see FIG. 19). The curing activation energy according to the Kissinger method were calculated to be 73.7 kJ/mol and 71.4 kJ/mol, respectively. The thermal stabilities of these two vitrimers were investigated by TGA, as shown in FIG. 20. The Tonset was measure to be 241.3° C. and 221.1° C. for the two oligomeric phosphonated vitrimers. A UL94 vertical burning test (before burning FIG. 21a and after burning FIG. 20b) and PCFC result (FIG. 21c) of the oligomeric phosphonated vitrimer is shown in FIG. 21.

1.-15. (canceled)

16. An epoxy thermoset polymer comprising
0.5 to 10 wt-% phosphorous,
phosphonate triple-bonded epoxy thermosets,
wherein the phosphonate forms a chain member within the epoxy thermoset polymer network and is covalently triple bonded to the polymer network via a phosphonate P—C and two P—O bonds.

17. The epoxy thermoset polymer according to claim 16, wherein the polymer comprises 1 to 8 or 2 to 6 wt-% phosphorous.

18. The epoxy thermoset polymer according to claim 16 or 17, wherein the phosphonate in the polymer has formula (I) 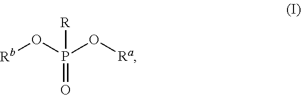
wherein
R is a reacted epoxy moiety within the epoxy thermoset polymer,
R^{a} and R^{b} are selected from reacted epoxy moieties and/or a further phosphonate moiety coupled to at least one reacted epoxy moiety within the epoxy thermoset polymer,
all of R, R^{a} and R^{b} are directly or indirectly bound to reacted epoxy moieties.

19. The epoxy thermoset polymer according to any of claims 16 to 18, wherein the phosphonate in the epoxy thermoset polymer has formula (II) 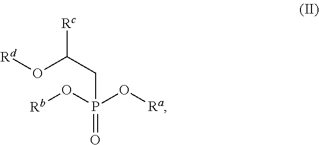
wherein
R^{a} and R^{b} are reacted epoxy moieties and/or a further phosphonate moiety coupled to at least one epoxy moiety within the epoxy thermoset polymer,
R^{c} is a reacted epoxy moiety, and
R^{d} is hydrogen or a reacted epoxy moiety or a phosphonate moiety coupled to at least one reacted epoxy moiety within the thermoset epoxy polymer.

20. The epoxy thermoset polymer according any of claims 16 to 19, wherein the phosphonate within the epoxy thermoset polymer is the result of mono, bis, tris or oligo H-phosphonates, optionally bis-H-phosphonates, optionally pentaerythrityl bis-H-phosphonates, 2,4,8,10-tetraoxa-3,9-diphosphaspiro[5.5]undecane-3,9-dioxide, or an oligomer of pentaerythrityl bis-H-phosphonates.

21. The epoxy thermoset polymer according any of claims 16 to 20, wherein the epoxy thermoset polymer comprises 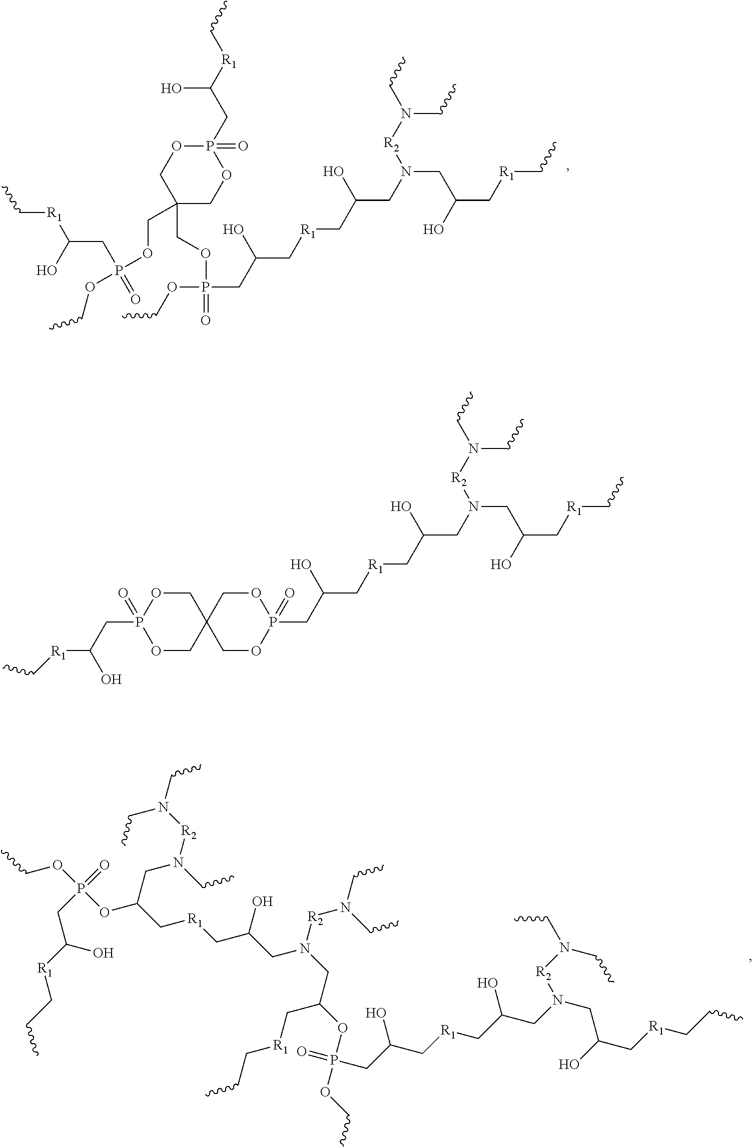 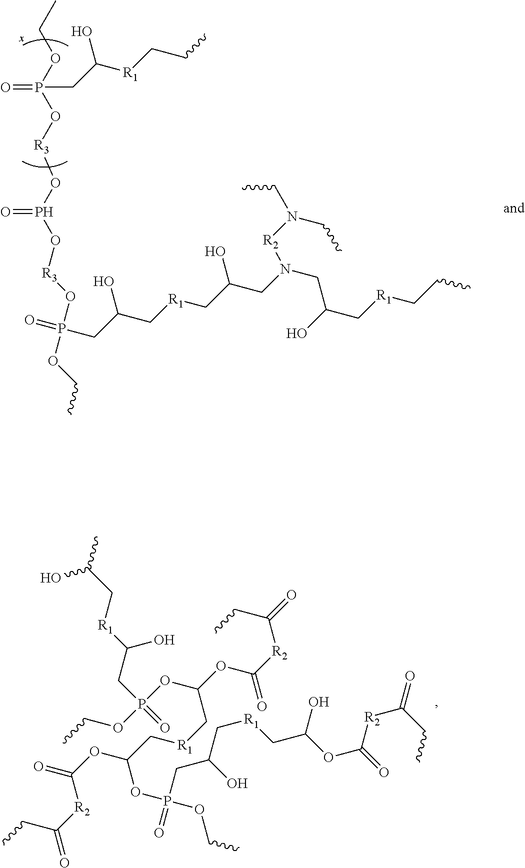
wherein
the wave lines form part of the epoxy thermoset polymer network,
R¹ are epoxy resin moieties,
and R² are epoxy hardener moieties, optionally amine or carboxylic epoxy hardener moieties, R³ are polyols, and x=0 to 10, optionally 1 to 8 or 2 to 6.

22. The epoxy thermoset polymer according to any of claims 16 to 21, wherein the epoxy moieties, optionally R¹, are selected from the group consisting of bisphenol-based, bisphenol-A-based, aliphatic, cycloaliphatic, aromatic, bis, tris and multifunctional, halogenated, Novolak, glycidylamine-based epoxy resins and other epoxy resins based on the epoxy of formula (III) 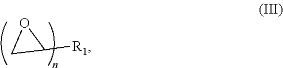
wherein R¹ is optionally selected from the group consisting of 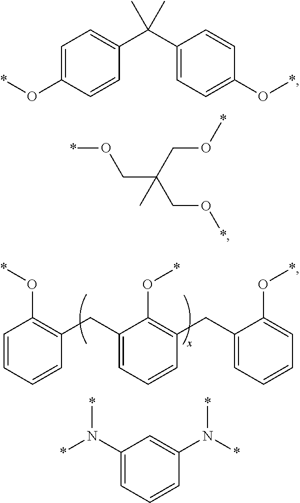
wherein
* are bonding points
n is 2 to 4; and
x is 0 to 4.

23. The thermoset epoxy polymer according any of claims 16 to 22, wherein the epoxy hardener moiety, optionally R₂, is selected from the group consisting of amine epoxy hardeners, carboxylic epoxy hardeners, anhydride epoxy hardeners, acid anhydride epoxy hardeners, and acid epoxy hardeners, optionally selected from the group of amine epoxy hardeners according to formula (V) 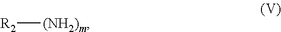
wherein R₂ is selected from the group consisting of 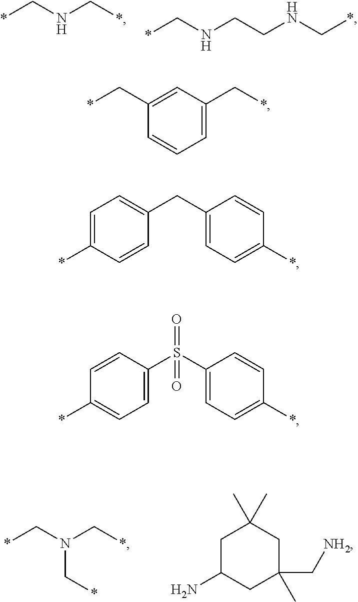
m is 1, 2 or 3
* indicates the attachment bond of R₂,
optionally selected from the group of acid anhydride and carboxylic acid hardeners, optionally 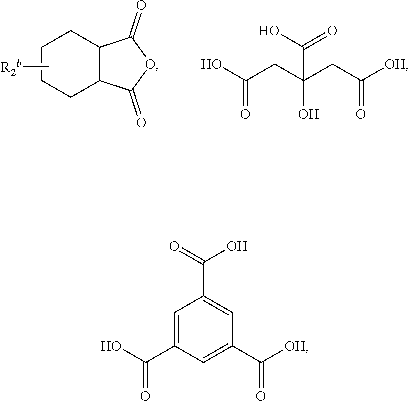
wherein R_{2b} is H or CH₃.

24. A method for preparing an epoxy thermoset polymer according to any of claims 16 to 23 comprising the steps:
(a) providing epoxy resin reactants;
(b) adding, mixing and reacting an H-phosphonate, optionally selected from the group consisting of mono, bis, tris and oligo H-phosphonates, pentaerythrityl bis-H-phosphonates, 2,4,8,10-tetraoxa-3,9-diphosphaspiro[5.5]undecane-3,9-dioxide, and oligomers of pentaerythrityl bis-H-phosphonates, with the epoxy resin reactants, optionally with organic base, optionally with 1,5,7-triazabicyclo[4.4.0]dec-5-en) (TBD), optionally heating, optionally heating to 50 to 90° C.;
(c) adding, mixing and reacting at least one epoxy thermoset hardener to the composition of (b);
(d) heating the composition, optionally heating from 50 to 200° C., optionally from 80 to 160° C., optionally for 1 to 20, optionally 4 to 10 hours;
wherein optionally a transesterification catalyst can be added in step (b), (c) or (d) (vitrimer formation), optionally heating to activate transesterification.

25. The method of claim 24, wherein a transesterification catalyst is added in step (b).

26. The method of claim 24 or 25, wherein epoxy resin reactants are selected from the group consisting of bisphenol-based, optionally bisphenol-A-based, aliphatic, cycloaliphatic, aromatic, bis, tris and multifunctional, halogenated, Novolak, bio- and glycidylamine-based epoxy resins.

27. The method of any of claims 24 to 26, wherein the curing agent is selected from the group consisting of aliphatic or aromatic amines, carboxylic anhydrides, carboxylic acids, and polyols.

28. An epoxy thermoset polymer according to any of claims 16 to 23 obtained or obtainable by a method according to any of claims 24 to 27.

29. Use of a thermoset epoxy polymer according to any of claims 16 to 23 for fire safe materials, optionally fire safe polymers or composites, fire safe textiles, re-processable polymers or composites, damage reparable polymers, composites or coatings, 3D-printable polymers and composites, extrudable polymers and composites.

30. A product selected from the group consisting of fire safe materials, optionally fire safe polymers or composites, fire safe textiles, re-processable polymers or composites, damage reparable polymers, composites or coatings, 3D-printable polymers and composites, extrudable polymers and composites comprising a thermoset epoxy polymer according to any of claims 16 to 23.
